(19) United States
(12) Patent Application Publication
(10) Pub. No.: US 2026/0343417 A1
(43) Pub. Date: Oct. 29, 2026

(54) DYNAMIC POWER SAVING-AWARE RELAY OPERATIONS IN WIRELESS NETWORKS

(71) Applicant: NEWRACOM, Inc., Irvine, CA (US)

(72) Inventors: Jaehyuk CHOI, Seongnam (KR); Joonsoo LEE, Irvine, CA (US)

(73) Assignee: NEWRACOM, Inc., Irvine, CA (US)

(21) Appl. No.: 19/659,898

(22) Filed: Apr. 27, 2026

Related U.S. Application Data
(60) Provisional application No. 63/796,150, filed on Apr. 28, 2025.

(51) Int. Cl. H04W 52/02; H04L 5/00; H04W 72/20

(52) U.S. Cl. CPC H04W 52/0274; H04L 5/0053; H04W 72/20

(57) ABSTRACT

A method performed by a relay station (STA) to act as a relay between an access point (AP) and a relayed STA. The method includes receiving, while operating in a low capability mode of a dynamic power saving scheme, an initial control frame from the AP and responsive to receiving the initial control frame, transitioning to operating in a high capability mode of the dynamic power saving scheme and transmitting an initial control response frame to the AP, wherein the transmitting of the initial control response frame serves to inform the relayed STA that the relay STA will be relaying data. The method further includes receiving, while operating in the high capability mode, a first physical layer protocol data unit (PPDU) from the AP that carries data intended for the relayed STA and transmitting a second PPDU to the relayed STA that includes the data intended for the relayed STA.

### CROSS-REFERENCE TO RELATED APPLICATION

This application claims the benefit of U.S. Provisional Application No. 63/796,150, filed Apr.28, 2025, titled “Dynamic Power Save-Enabled Relay Operation in Wireless LANs”, which is hereby incorporated by reference.

### TECHNICAL FIELD

The present disclosure generally relates to wireless communications, and more specifically, relates to dynamic power saving-aware relay operations in wireless networks.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

As wireless local area networks (WLANs) evolve to meet growing demands for throughput, energy efficiency, and low-latency real-time applications (RTAs), recent wireless networking standards under development such as IEEE 802.11be (also referred to as Wi-Fi 7) and IEEE 802.11bn (also referred to as Wi-Fi 8 or UHR) have introduced new features such as multi-link operation (MLO) and restricted target wake time (r-TWT). MLO is a technology that enables devices to transmit and receive traffic over multiple links in different channels/bands. r-TWT is a technology that provides guaranteed service periods for selected devices. The use of MLO and/or r-TWT can help reduce channel contention.

Another feature that is gaining interest in the wireless network industry is relay technology. Relay technology may help enhance wireless network coverage and throughput. With relay technology, a relay station (STA) that is communicatively situated between an access point (AP) and a non-AP STA may relay traffic between the AP and the non-AP STA to improve reliability and throughput for the non-AP STA. The use of relay technology may help extend wireless network coverage in dense or obstructed environments and enable uninterrupted service over larger areas.

With existing relay technologies, relay STAs (rSTAs) always remain fully awake and function at maximum capacity, which can lead to unnecessary power consumption during idle periods (when there is no traffic to relay) or low-traffic periods.

Dynamic power save (DPS) is a technology that allows a device to dynamically transition between operating in a high capability mode and operating in a low capability mode. When operating in the high capability mode, the device can transmit and receive data at full capacity. When operating in the low capability mode, the device is technically awake but minimizes transmissions to conserve energy.

Existing wireless networks do not provide a way for relay STAs to leverage DPS functionality, which may limit the wireless network’s ability to conserve energy in relay scenarios and hamper overall energy efficiency. Also, there is no defined procedure for the AP and the relayed STA to become aware of the relay STA’s DPS capabilities or DPS mode transition logic. As a result, APs and relayed STAs cannot make informed scheduling decisions, which may result in missed transmissions and excessive/unnecessary power usage. Also, there is no defined procedure for the relay STA to become aware of the relayed STA’s DPS capabilities or DPS mode transition logic. To ensure robust connectivity, the relay STA's DPS operations need to take into account the DPS capabilities of its associated relayed STAs. For example, if a relayed STA does not support DPS (e.g., it is a legacy STA), then the relay STA may need to operate in the high capability mode more persistently to maintain connectivity, but this may result in excessive/unnecessary power usage.

The absence of DPS awareness in relay scenarios may result in inefficiencies in both transmission scheduling and power management.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a wireless network environment with an access point (AP), relay stations (STAs), and STAs that are capable of multi-link operation (MLO) in a 2.4 Gigahertz (GHz) band and a 5 GHz band, according to some embodiments.

FIG. 11 is a diagram showing a single link operation and a multi-link operation between an AP and a non-AP STA, according to some embodiments.

FIG. 12 is a diagram showing a relay STA multi-link device (MLD) that can relay traffic between an AP MLD and a non-AP STA MLD using MLO, according to some embodiments.

FIG. 13 is a diagram showing dynamic power save (DPS) operations, according to some embodiments.

FIG. 14 is a diagram showing a relay configuration/setup procedure without explicit DPS capability exchange, according to some embodiments.

FIG. 15 is a table showing a structure of a DPS feature capabilities information element (IE), according to some embodiments.

FIG. 16 is a diagram showing a relay configuration/setup procedure that includes explicit DPS capability exchange via a re-association request and response exchange, according to some embodiments.

FIG. 17 is a diagram showing a relay operation sequence, according to some embodiments.

FIG. 18 is a diagram showing a DPS-enabled relay operation sequence with a two-stage ICF/ICR exchange, according to some embodiments.

FIG. 19 is a diagram showing a downlink relay operation sequence that uses a dual-purpose initial control response frame signaling technique, according to some embodiments.

FIG. 20 is a flow diagram of a method for acting as a relay between an AP and a relayed STA, according to some embodiments.

FIG. 21 is a flow diagram of a method for receiving data from an AP via a relay STA, according to some embodiments.

### DETAILED DESCRIPTION

The present disclosure generally relates to wireless communications, and more specifically, relates to dynamic power saving-aware relay operations in wireless networks.

As mentioned above, the absence of dynamic power save (DPS) awareness in relay scenarios may result in inefficiencies in both transmission scheduling and power management. The present disclosure describes a dynamic power saving-aware relay framework to explicitly signal dynamic power saving capabilities in relay scenarios and to support dynamic and energy-efficient operations while maintaining reliable forwarding/relay operations. For explanation purposes, the dynamic power saving-aware relay framework is primarily described herein in a context that uses DPS as the dynamic power saving scheme. It should be appreciated that the framework can be implemented with other types of dynamic power saving schemes besides DPS.

The dynamic power saving-aware relay framework described herein may provide bi-directional dynamic power saving awareness between relay STAs and relayed STAs to allow the STAs to leverage dynamic power saving during relay operations more effectively. The dynamic power saving-aware relay framework may be designed to align with existing wireless networking standards to enable explicit coordination and signaling of dynamic power saving capabilities specifically for relay scenarios. For example, the dynamic power saving-aware relay framework may provide a new dynamic power save (DPS) feature capabilities information element (IE) that enables STAs involved in relay operations (e.g., a relay STA and/or a relayed STA) to explicitly communicate/signal its DPS capabilities (e.g., whether the STA supports low capability (LC) mode and/or whether the STA supports initial control frame (ICF) and initial control response frame (ICR) signaling) during relay setup, association, or re-association procedures. This may allow both APs and relayed non-AP STAs to become aware of the relay STA’s DPS capabilities/behavior, enabling intelligent scheduling decisions that help conserve energy without compromising the reliability of relayed transmissions.

Also, the dynamic power saving-aware relay framework may provide a dual-purpose initial control response frame signaling technique that enables efficient dynamic power saving mode transitions (e.g., transition from operating in a low capability mode to operating in a high capability mode) using a single initial control response frame. The single initial control response frame may serve a dual purpose in that it can serve as a response to the initial control frame transmitted by the AP and also serve to inform the relayed STA that data will be relayed to the relayed STA so the relayed STA should get ready to transition dynamic power saving modes. Such approach may help reduce signaling overhead and enhance energy efficiency, while ensuring robust relay operations.

The dynamic power saving-aware relay framework described here may provide several benefits including one or more of the benefits mentioned below.

Enhanced power efficiency: by explicitly signaling dynamic power saving capabilities, the relay STA and relayed STAs may know when dynamic power saving can be leveraged to reduce power consumption during idle periods or low-activity periods.

Reduced signaling overhead: the dual-purpose initial control response frame signaling technique may reduce the number of frames that are needed to effectuate dynamic power saving mode transitions, which can reduce the overall signaling overheard and latency and increase channel utilization.

Seamless compatibility: the DPS feature capabilities IE may seamlessly integrate into existing management frames defined in the IEEE 802.11 wireless networking standards (e.g., association request/response frame, re-association request/response frame, and/or relay setup request frames), which enables seamless integration and adoption into existing wireless networks.

Improved reliability and scalability: the clear and explicit communication/signaling of DPS capabilities may enhance the reliability of data forwarding/relay across extended coverage areas and provide a scalable solution that can help meet the evolving requirements of next-generation wireless networks.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

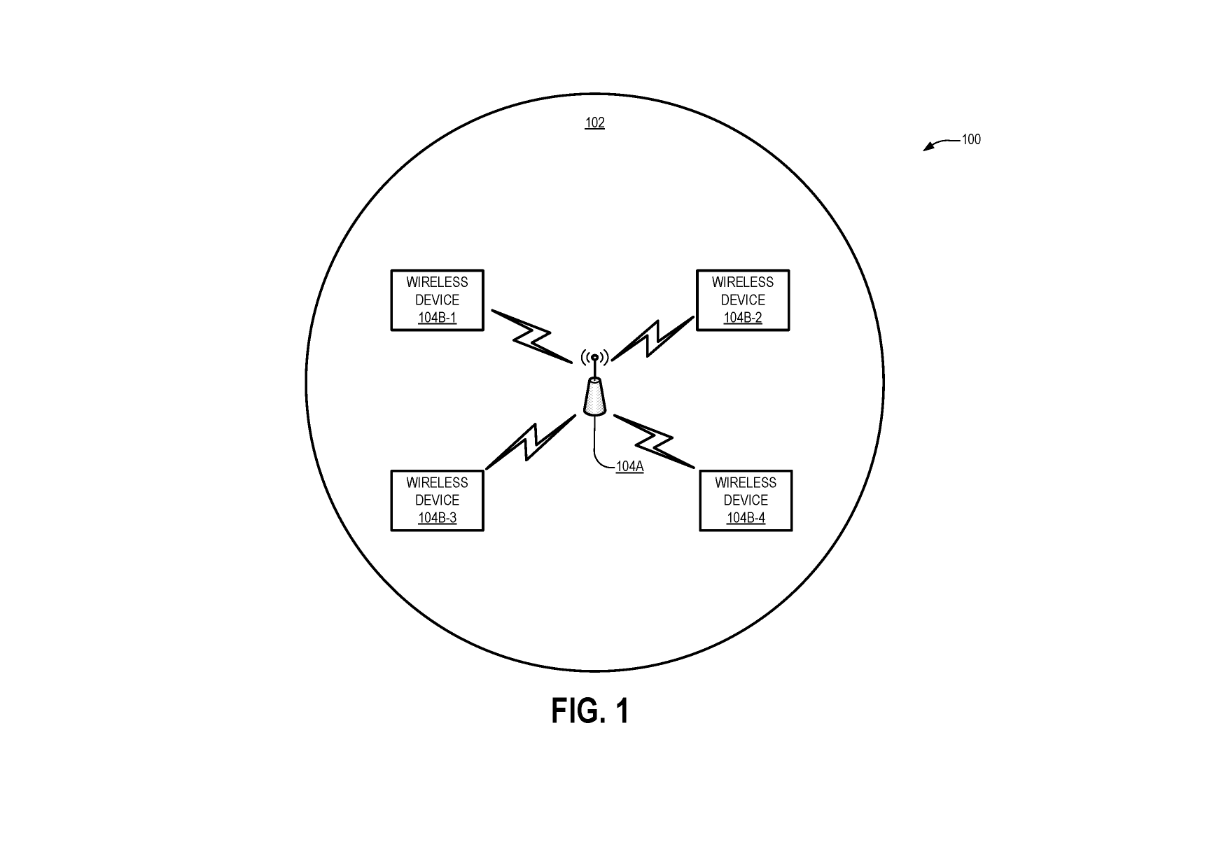

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

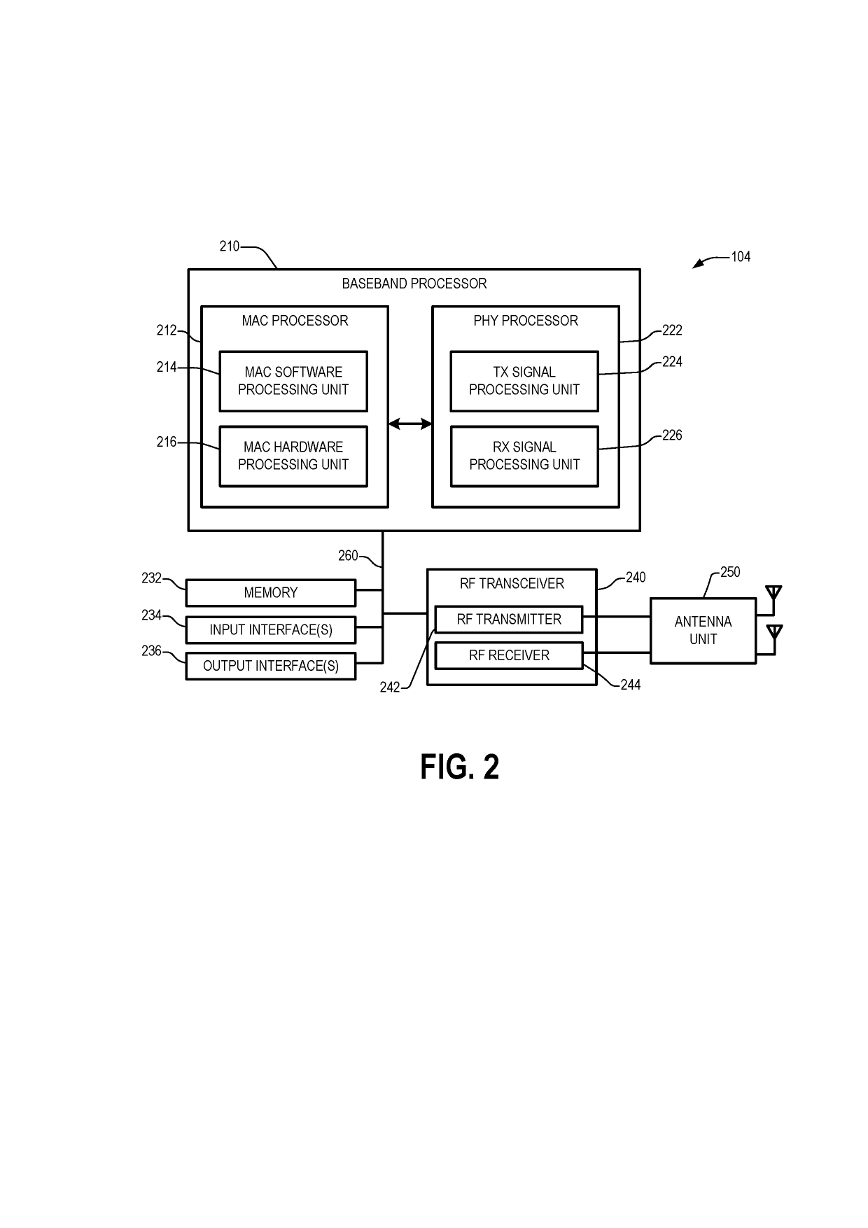

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

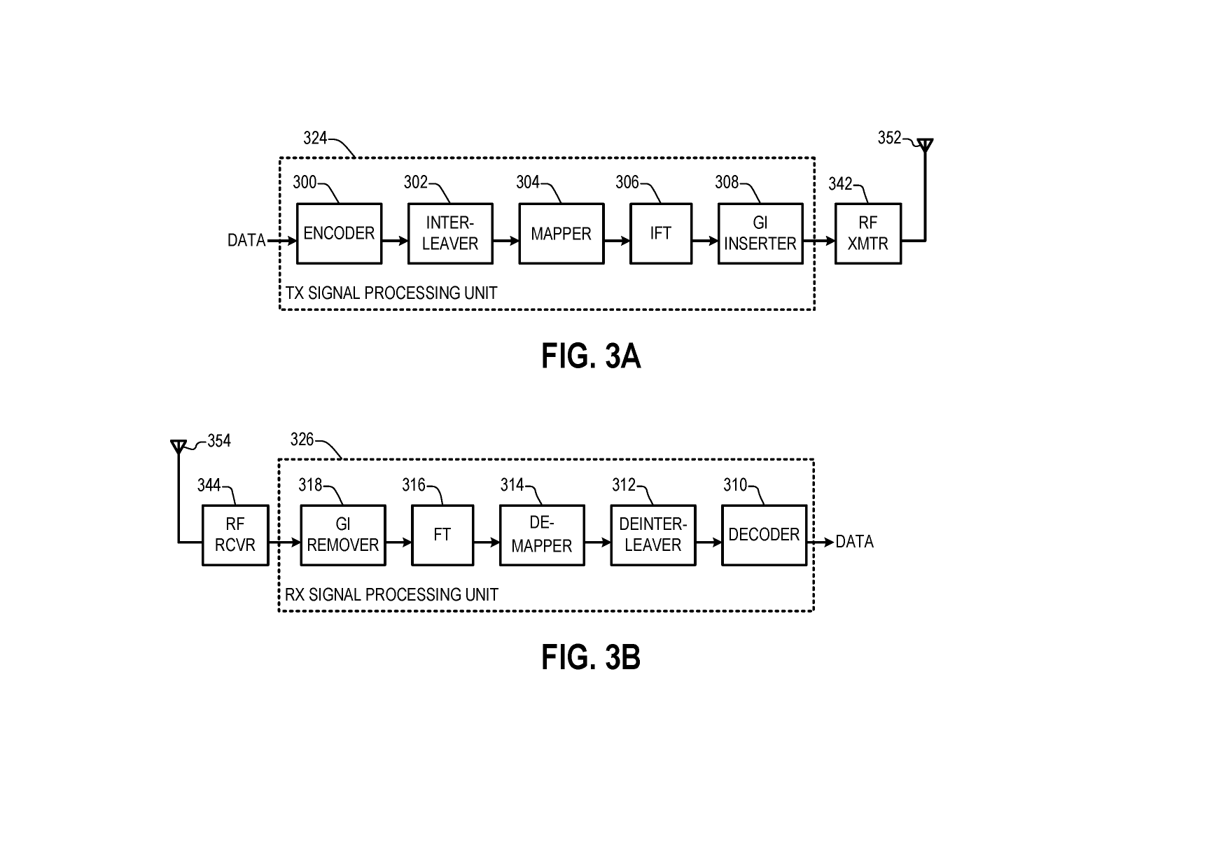

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

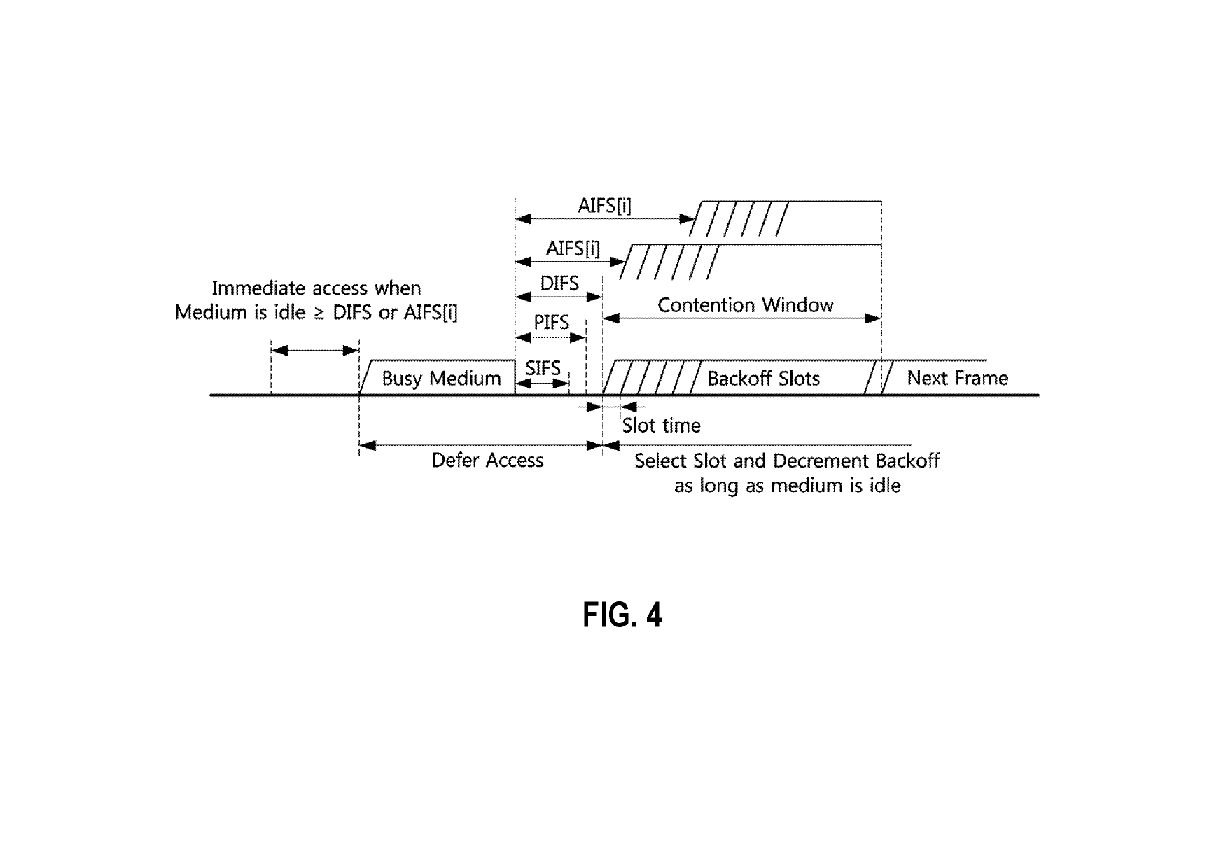

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

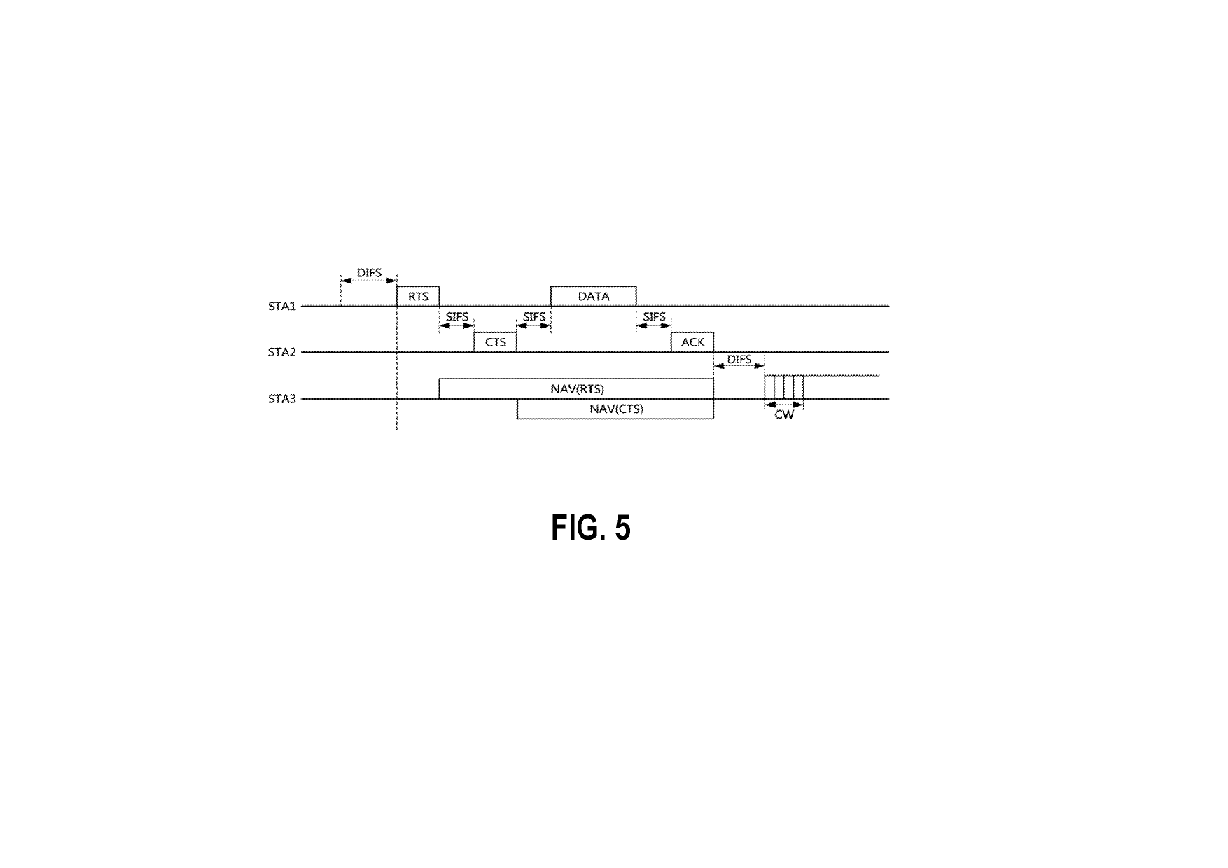

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS + CTS frame duration + SIFS + data frame duration + SIFS + ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

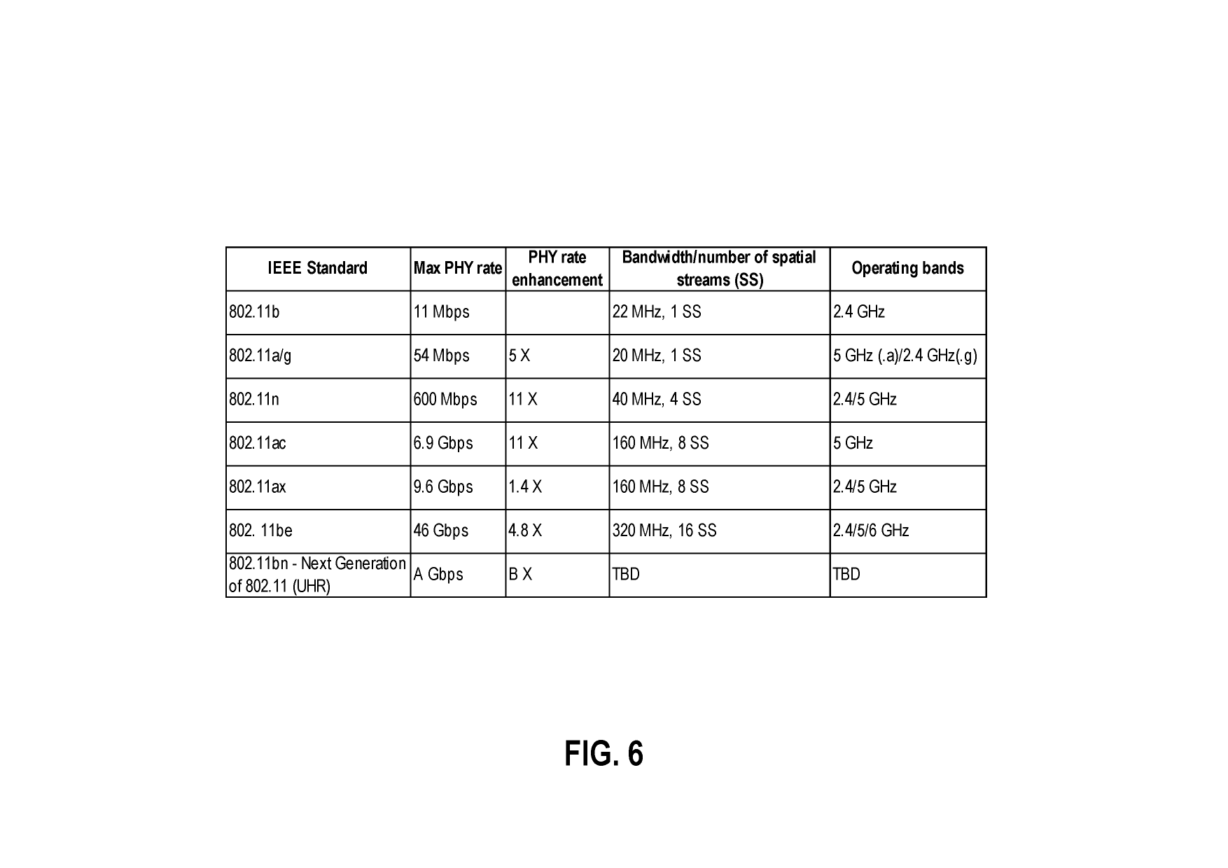

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925– 7.125 GHz) is being considered for unlicensed use. This would allow APs and STAs to become tri-band devices. Larger than 160MHz data transmissions (e.g., 320 MHz or 640 MHz) could be considered to increase the maximum PHY rate. For example, 320 MHz or 160+160MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

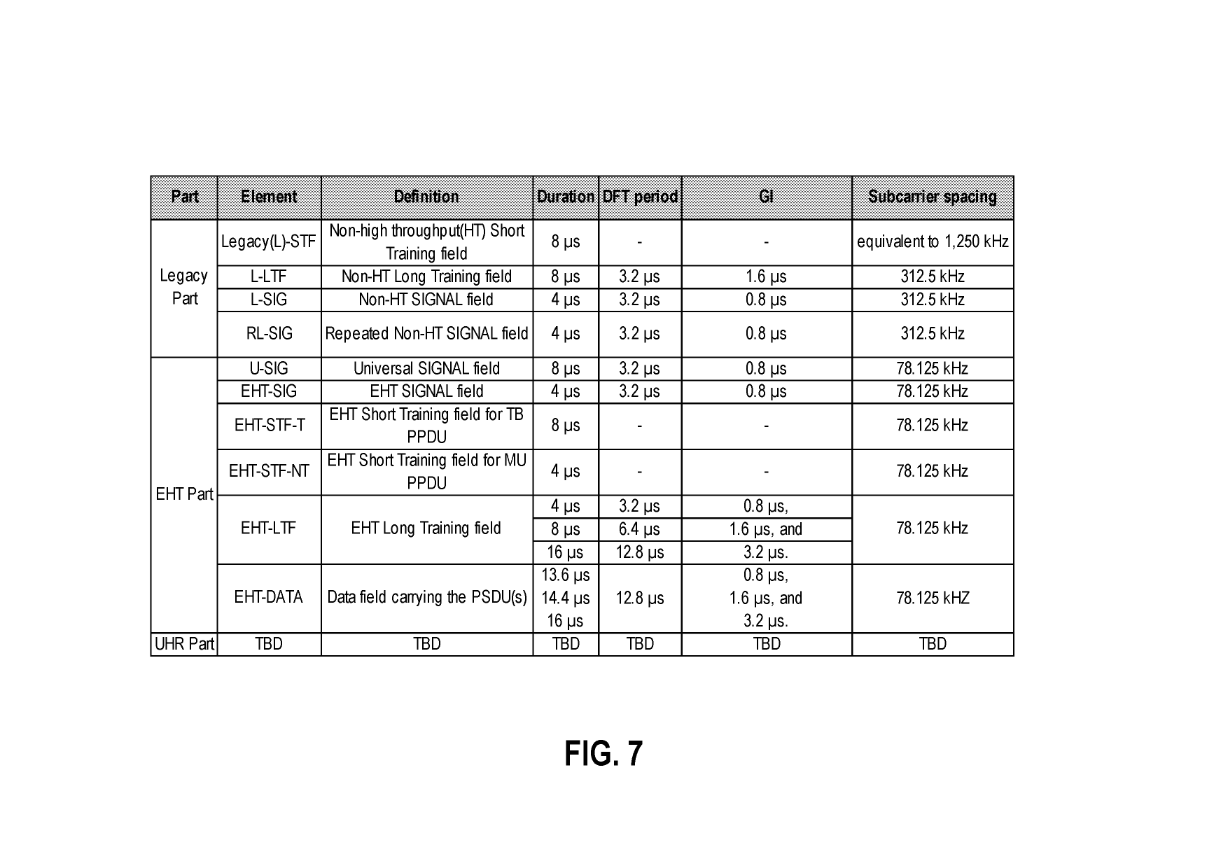

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

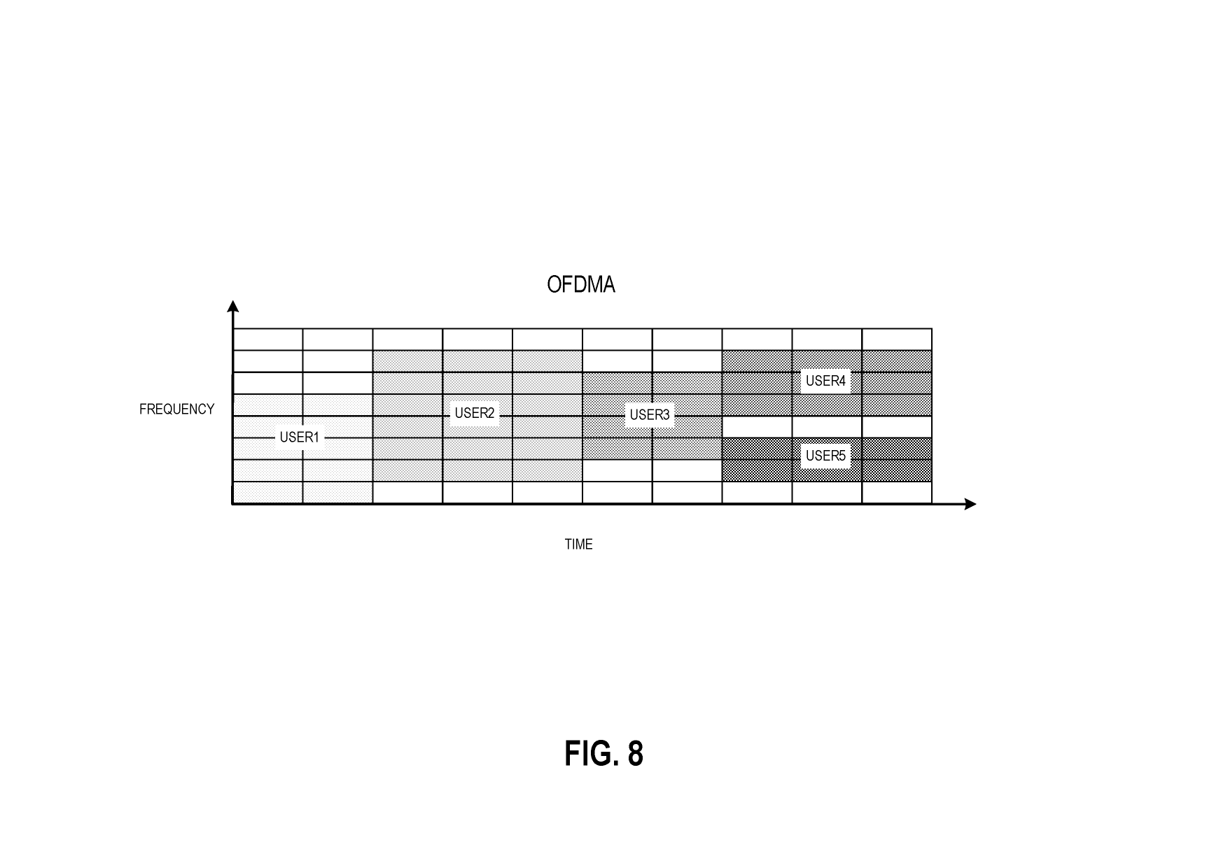

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

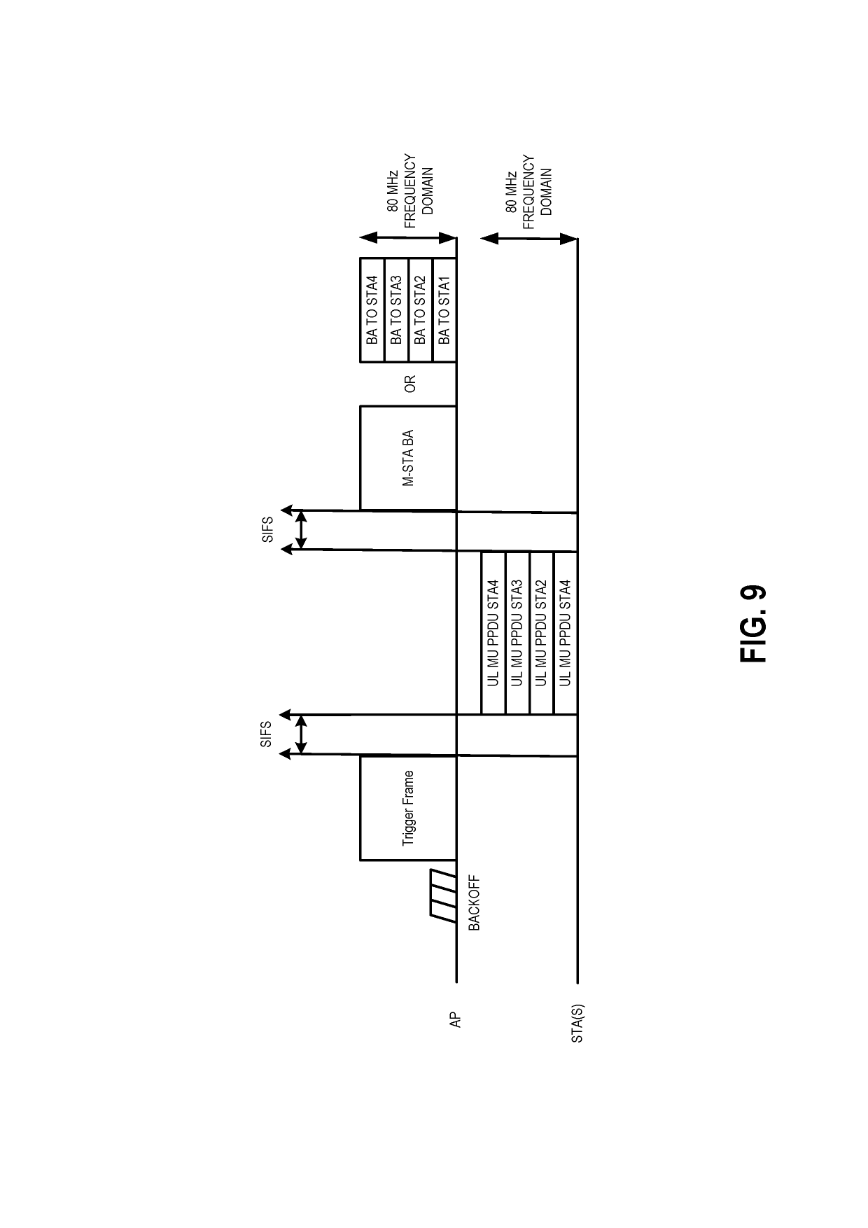

FIG. 9 illustrates an example scenario where an access point (AP) operating in an 80MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

As used herein, a dynamic power saving scheme is a type of scheme that allows devices to transition between different power consumption modes (e.g., between a high capability mode and a low capability mode) on demand (e.g., via signaling). DPS (dynamic power save) is an example of a dynamic power saving scheme.

As used herein, a multi-link device (MLD) is a device that is capable of transmitting and receiving traffic over multiple links in different channels/bands. A MLD may implement multi-link operation (MLO). Multi-link operation (MLO) is a technology that enables devices to transmit and receive traffic over multiple links in different channels/bands.

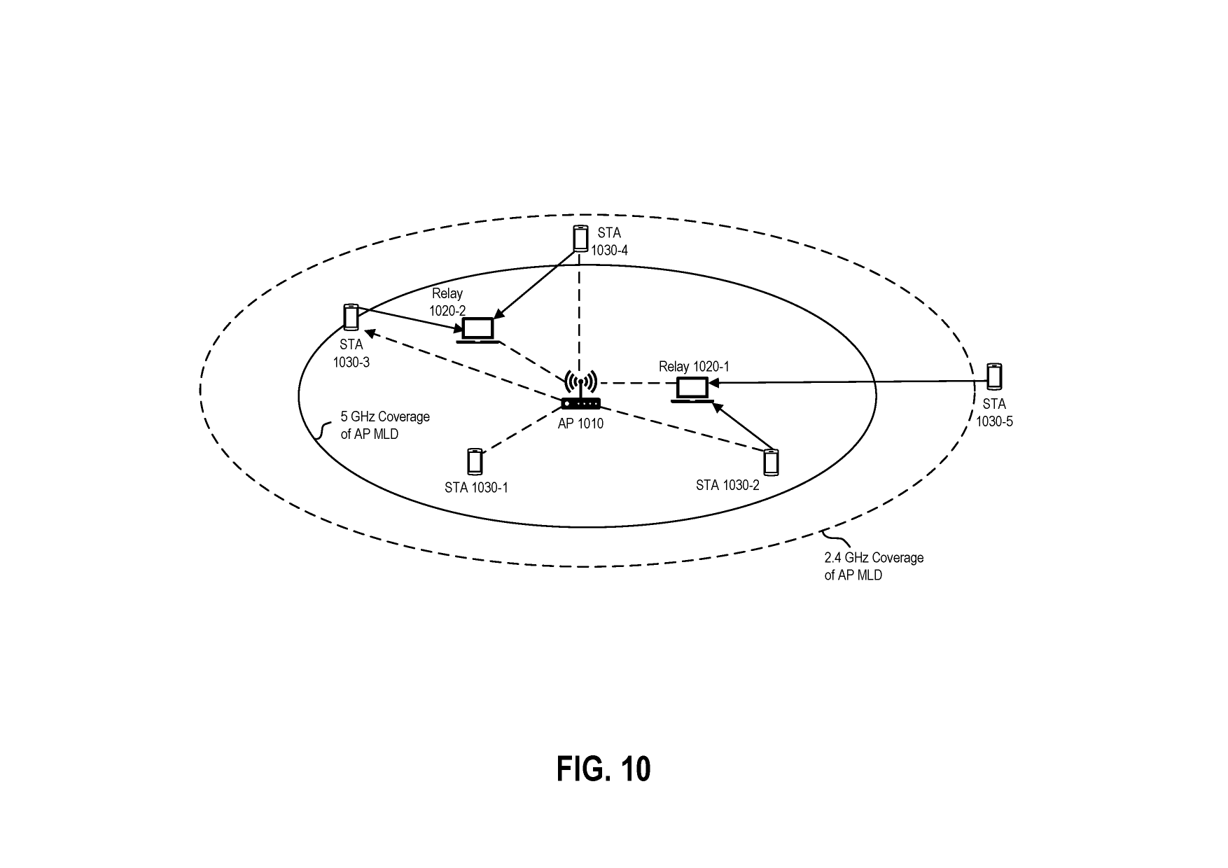

FIG. 10 is a diagram showing a wireless network environment with an AP, relay STAs, and STAs that are capable of MLO in a 2.4 GHz band and a 5 GHz band, according to some embodiments.

As shown in the diagram, the wireless network environment may include an AP 1010, two relay STAs (relay STA 1020-1 and relay STA 1020-2), and five non-AP non-relay STAs (STA 1030-1, STA 1030-2, STA 1030-3, STA 1030-4, and STA 1030-5). The AP 1010, relay STAs 1020, and STAs 1030 may be MLDs that are capable of MLO. Unlike traditional non-MLD APs and non-MLD STAs, MLD APs and STAs (also referred to herein as AP MLDs and STA MLDs, respectively) may have multiple wireless interfaces and may be capable of MLO in multiple channels/bands. In this example, it is assumed that the AP 1010, relay STAs 1020, and non-relay STAs 1030 are capable of MLO in a first channel in the 2.4 GHz band and a second channel in the 5 GHz band. It is noted that MLDs having multiple wireless interfaces may still have a unique MAC instance at the upper layers, without losing the independent parameters of each wireless interface.

The AP 1010 may operate a basic service set (BSS) in the 2.4 GHz band and the 5 GHz band (using two wireless interfaces). In the example shown in the diagram, the AP’s 1010 coverage area in the 2.4 GHz band (shown in a dotted line/oval) may extend further than the AP’s 1010 coverage area in the 5 GHz band (shown in a solid line/oval) (due to the 2.4 GHz band being a lower frequency band).

The relay STAs (relay STA 1020-1 and relay STA 1020-2) may act as a relay for STAs 1030 (and thus relay traffic between the STAs 1030 and the AP 1010). For example, relay STA 1020-1 may act as a relay for STA 1030-2 and STA 1030-5 (e.g., relay traffic from STA 1030-2 and STA 1030-5 to the AP 1010 and/or in the opposite direction). Similarly, relay STA 1020-2 may act as a relay for STA 1030-3 and STA 1030-4 (e.g., relay traffic from STA 1030-3 and STA 1030-4 to the AP 1010 and/or in the opposite direction).

For sake of explanation only, various embodiments may be described herein in the context of the wireless network environment shown in FIG. 10. It should be appreciated, however, that the techniques described herein may be applicable to other wireless network environments having different topologies.

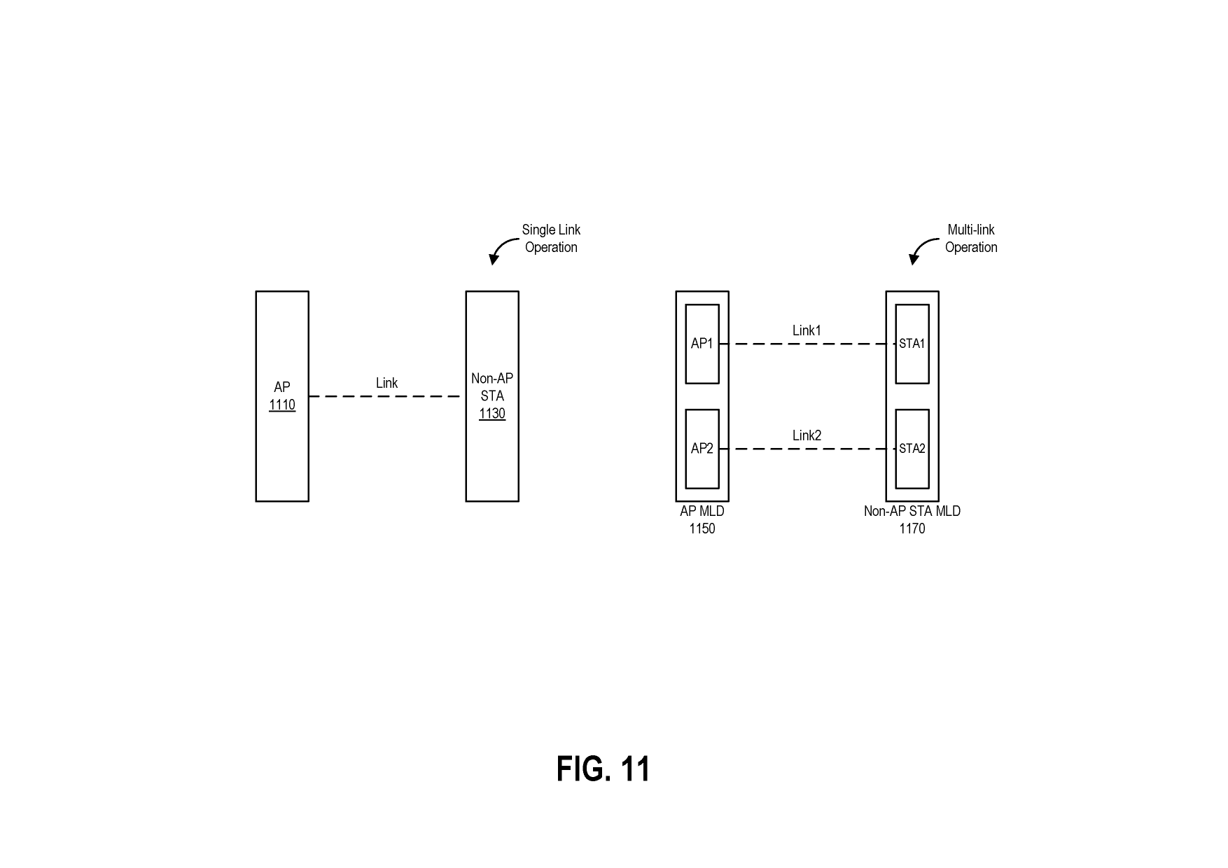

FIG. 11 is a diagram showing a single link operation and a multi-link operation between an AP and a non-AP STA, according to some embodiments.

As shown in the diagram, with a single link operation, an AP 1110 and a non-AP STA 1130 may communicate with each other over a single link in a single frequency band. In contrast, with MLO, an AP MLD 1150 and a non-AP STA MLD 1170 may communicate with each other over multiple links in multiple frequency bands (e.g., 2.4 GHz and 5 GHz frequency bands) to improve link reliability, enhance throughput, and/or support more robust and flexible communications. For example, as shown in the diagram, the AP MLD 1150 may have a first instance (“AP1”) and a second instance (“AP2”). Similarly, the non-AP STA MLD 1170 may also have a first instance (“STA1”) and a second instance (“STA2”). The AP MLD 1150 may communicate with the non-AP STA MLD 1170 over a first link (“Link1”) between AP1 and STA1 and also over a second link (“Link2”) between AP2 and STA2.

A relay STA (rSTA) may be a non-AP STA that can relay traffic between an AP and a non-AP STA. Relay operations may help extend the possible communication range and provide improved QoS (e.g., reliability and throughput) in a wireless network. For example, relay STA 1020-1 shown in FIG. 10 may relay traffic between the AP 1010 and STA 1030-2 and/or STA 1030-5. Also, relay STA 1020-2 shown in FIG. 10 may relay traffic between AP 1010 and STA 1030-3 and/or STA 1030-4. A relay STA may exclusively act as a relay or act as a relay while also acting as a non-relay STA.

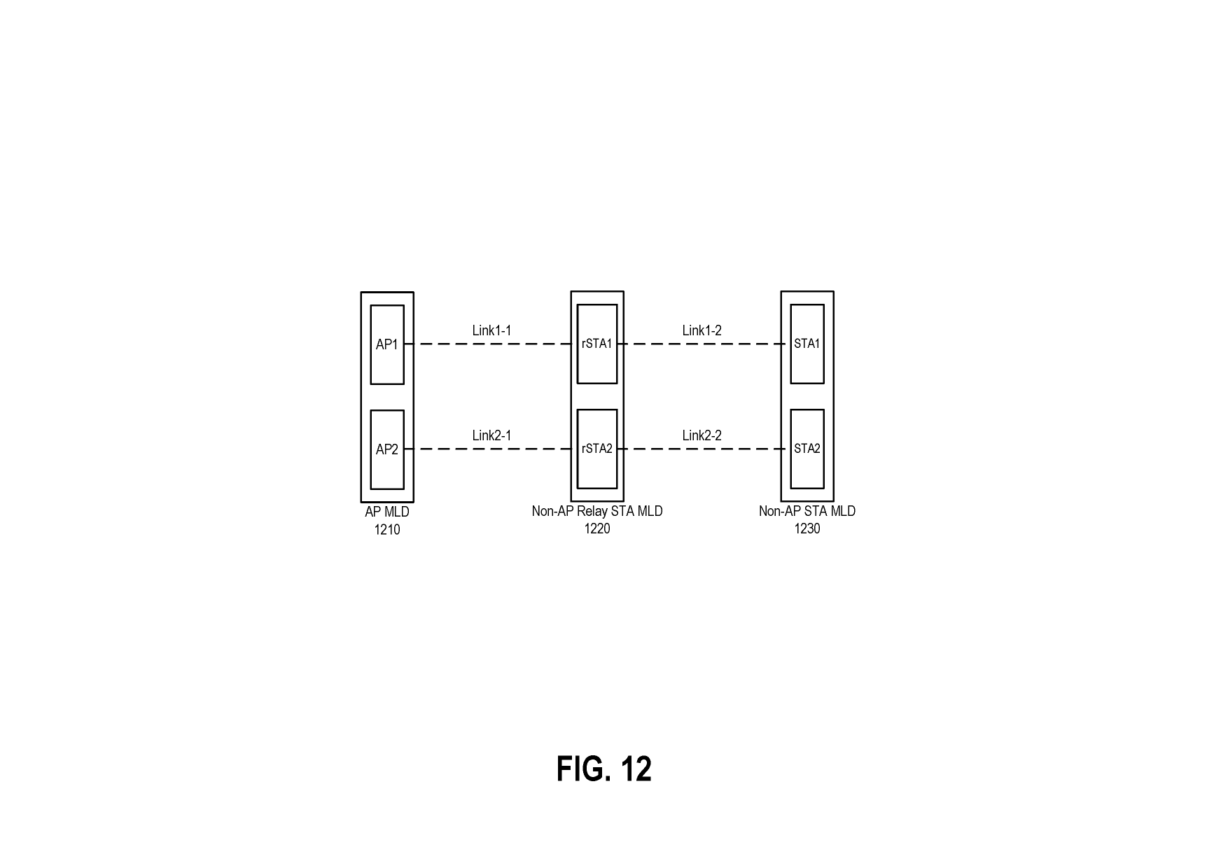

FIG. 12 is a diagram showing a relay STA MLD that can relay traffic between an AP MLD and a non-AP STA MLD using MLO, according to some embodiments.

When MLO is supported in a wireless network, the relay operations can also use MLO. For example, as shown in the diagram, an AP MLD 1210 may have a first instance (“AP1”) and a second instance (“AP2”), a relay STA MLD 1220 may have a first instance (“rSTA1”) and a second instance (“rSTA2”), and the non-AP STA MLD 1230 may have a first instance (“STA1”) and a second instance (“STA2”). AP1 and rSTA1 may communicate with each other over a link (“Link1-1”) that operates in a first channel (e.g., a channel in the 2.4 GHz band). rSTA1 and STA1 may communicate with each other over a link (“Link1-2”) that operates in the first channel. AP2 and rSTA2 may communicate with each other over a link (“Link2-1”) that operates in a second channel (e.g., a channel in the 5 GHz band) that is different from the first channel. rSTA2 and STA2 may communicate with each other over a link (“Link2-2”) that operates in the second channel. AP1 and STA1 may communicate with each other in the first channel via rSTA1. For example, downlink traffic going from AP1 to STA1 may be transmitted in the first channel over Link1-1 and Link1-2 (in that order) and uplink traffic going from STA1 to AP1 may be transmitted in the first channel over Link1-2 and Link1-1 (in that order). Similarly, AP2 and STA2 may communicate with each other in the second channel via rSTA2. For example, downlink traffic going from AP2 to STA2 may be transmitted in the second channel over Link2-1 and Link2-2 (in that order) and uplink traffic going from STA2 to AP2 may be transmitted in the second channel over Link2-2 and Link2-1 (in that order). In this way, the AP MLD 1210 may be able to communicate with the non-AP STA MLD 1230 via the relay STA MLD 1220 (using relay operations) in two different channels over two different sets of links. The links over which traffic is relayed may be referred to herein as relay links. For example, Link1-1, Link1-2, Link2-1, and Link2-2 may be considered to be relay links.

It is expected that next-generation wireless networks may use MLO for relay functionality. MLO allows devices to communicate simultaneously over multiple links operating in different frequency bands to enhance connectivity, coverage, and/or performance. Relay technology can be enhanced by leveraging MLO capabilities. For example, consider a scenario where a non-AP STA MLD equipped with two radios, operating in the 2.4 GHz and 5 GHz bands respectively, reaches the boundary of an AP's 5 GHz coverage area, experiencing weak link condition. In such a situation, the non-AP STA MLD may establish a 5 GHz link to the AP via a relay STA MLD that is communicatively situated between the AP and the non-AP STA, thereby effectively extending the coverage area and ensuring seamless connectivity even in areas with weak signal conditions beyond the AP's 5 GHz band coverage area. However, the relay techniques and concepts described herein are not limited to being used with MLO, but they are also applicable to conventional single-link technologies such as millimeter wave (mmWave) technology.

Although embodiments can be implemented in wireless networks that support MLO, for ease of understanding, various embodiments are primarily described from the perspective of an individual link. For example, as shown in FIG. 12, relay STA MLD 1220 can establish relay connectivity between the AP MLD 1210 and the non-AP STA MLD 1230 over multiple links. While relay STA MLD 1220 may use multiple interfaces/links to enhance overall relay performance, embodiments may be described in the context of an individual link to simplify explanations. Those skilled in the art will recognize that the techniques and concepts described herein can be implemented/realized in a wireless network that employs multiple links (through MLO). Thus, the techniques/concepts described herein may be applicable to both multi-link and single-link implementations.

DPS is a short-term/dynamic power saving scheme that has been introduced to enhance energy efficiency and responsiveness in the face of dynamic network conditions. DPS enables a STA to switch flexibly between operating in a high capability (HC) mode and operating in a low capability (LC) mode depending on the current traffic demands. The dynamic mode transitions can be controlled through lightweight signaling to allow the STA to reduce power consumption during idle or low-traffic periods without degrading performance. By alternating between operating in the high capability mode and the low capability mode, the STA can maintain efficient operations while still satisfying the varying requirements of real-time applications.

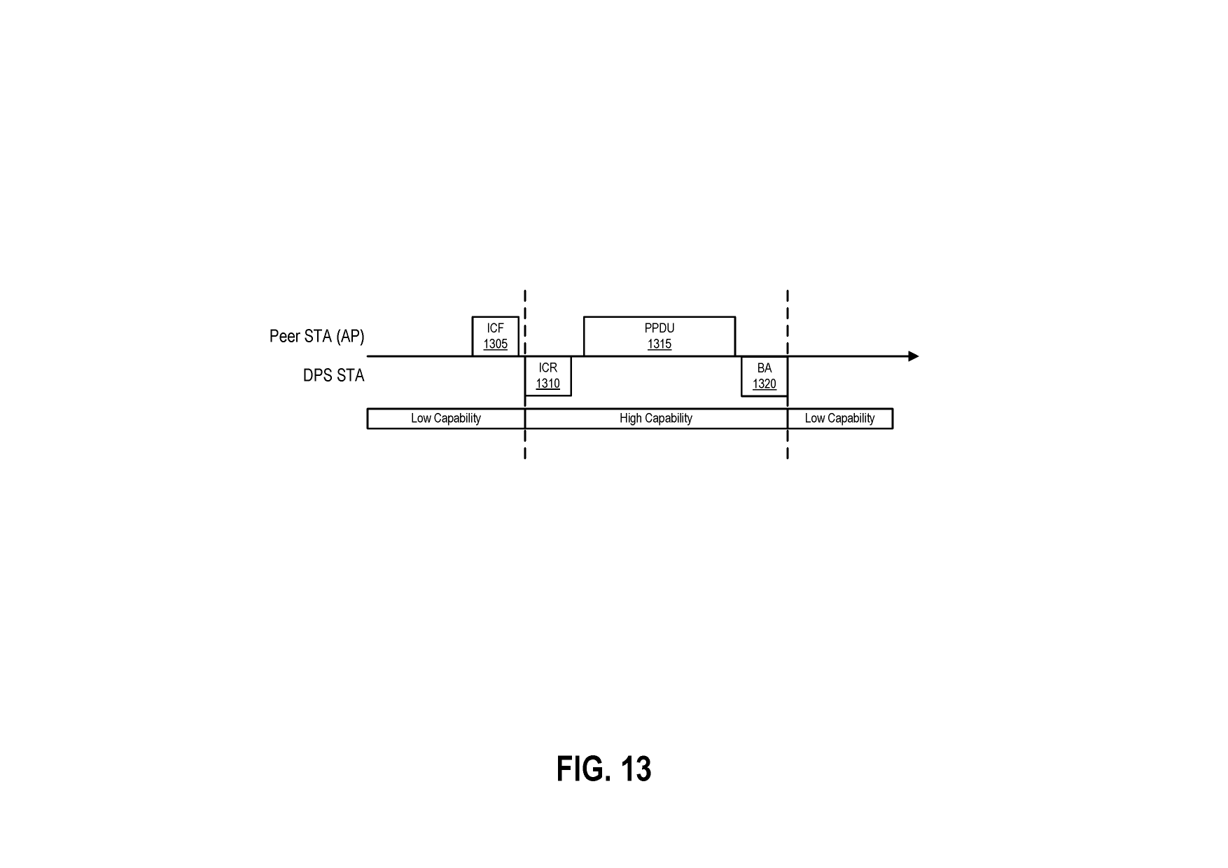

FIG. 13 is a diagram showing DPS operations, according to some embodiments.

DPS may allow a STA to dynamically alternate between operating in the low capability mode and the high capability mode, as needed. DPS is designed to optimize energy efficiency by allowing a STA to remain in the low capability mode until higher transmission capacity is required. When DPS is enabled, a STA may operate in the low capability mode most of the time to conserve energy. When a peer STA such as an AP needs to initiate a frame exchange or transmission opportunity (TXOP), it may transmit an initial control frame (ICF) 1305 to the DPS-enabled STA to cause the STA to transition from operating in the low capability mode to operating in the high capability mode. The initial control frame 1305 serves to instruct the DPS-enabled STA to switch DPS modes to support a higher data transmission rate.

Upon receiving the initial control frame 1305, the DPS-enabled STA may respond by transmitting an initial control response frame 1310 (ICR) to confirm that it has transitioned (or will transition) to operating in the high capability mode. The initial control frame 1305 may include padding to ensure that the DPS-enabled STA has sufficient time to transition to operating in the high capability mode. Since the DPS-enabled STA needs to successfully interpret the initial control frame 1305 before making the transition, an intermediate frame check sequence (FCS) field may be included in the initial control frame 1305 before the padding. This intermediate FCS field may allow the DPS-enabled STA to verify the initial control frame's 1305 integrity early and start the DPS mode transition early.

Once the DPS-enabled STA finishes transitioning to operating in the high capability mode, it can operate at full capacity for data transmission and reception. For example, as shown in the diagram, while the DPS-enabled STA operates in the high capability mode, the AP may transmit PPDU 1315 to the DPS-enabled STA and the DPS-enabled STA may respond by transmitting block ACK frame 1320 to the AP. After the frame exchange ends, the DPS-enabled STA may transition back to operating in the low capability mode to conserve energy until another high capacity transmission is needed.

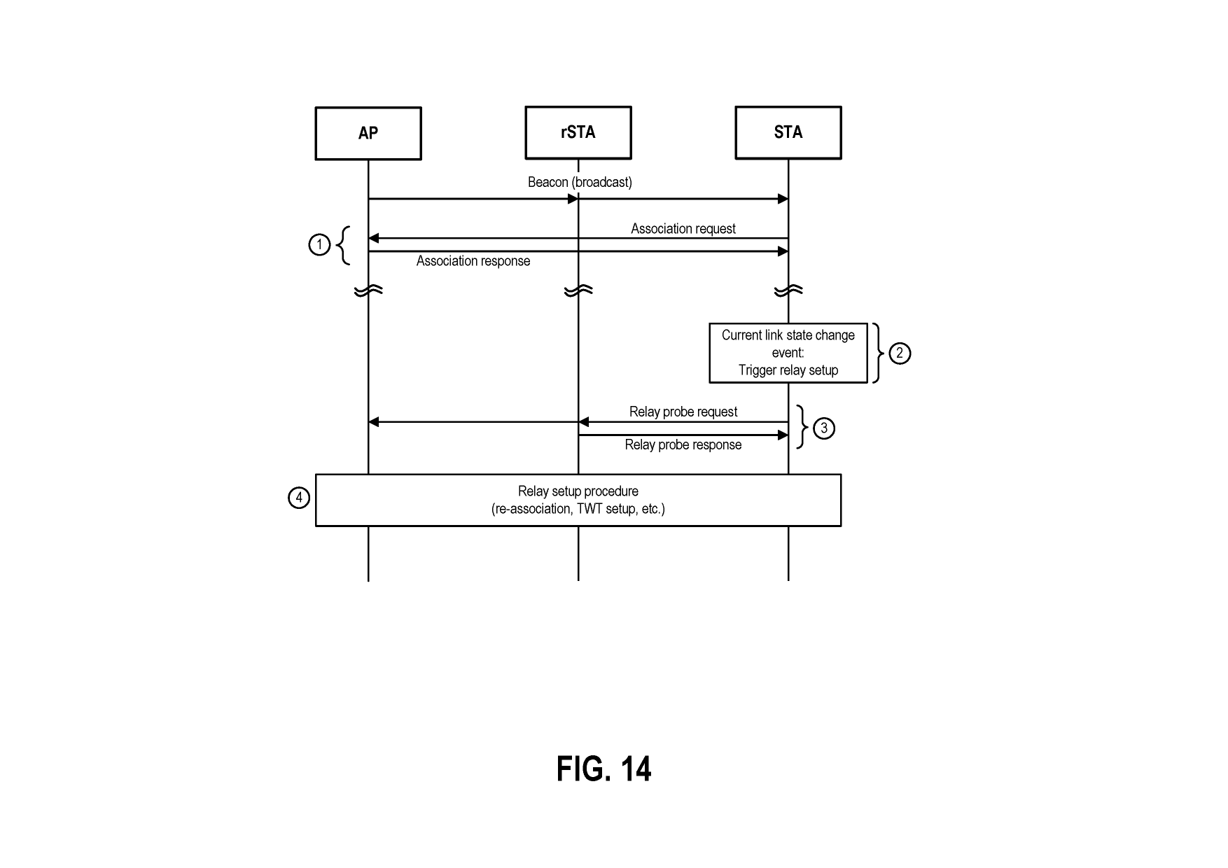

FIG. 14 is a diagram showing a relay configuration/setup procedure without explicit DPS capability exchange, according to some embodiments.

The diagram shows a signaling sequence for configuring a relay path in a wireless network. The signaling sequence may involve an AP that initiates and manages the relay configuration, a relay STA that is responsible for relaying traffic between the AP and the destination STA, and a destination STA that is to receive services through the established relay link. The destination STA may be considered to be a relayed STA in this context since it receives services via the relay STA.

As shown in the diagram, the AP may transmit (broadcast) a beacon frame to the relay STA and the destination STA. At step 1, the STA may initiate the establishment of a direct connection with the AP by transmitting an association request frame to the AP. Responsive to receiving the association request frame, the AP may transmit an association response frame to the destination STA. At this time, the STA has a direct connection with the AP. At step 2, a link state change event may occur (e.g., due to STA mobility or signal degradation) that prompts the need for reevaluating the connection with the AP. At step 3, in response to detecting the link state change event, the destination STA may initiate a relay setup procedure by transmitting a relay probe request frame to the relay STA and the relay STA may forward the relay probe request frame to the AP. The relay probe request frame may serve as a request that communication be routed through the relay STA to maintain robust connectivity. Responsive to receiving the relay probe request frame, the relay STA may transmit a relay probe response frame to the destination STA.

At step 4, following the relay probe request frame and replay probe response frame exchange, a relay setup procedure may be executed. This may include re-association processes to reestablish connectivity between the destination STA and the AP via the relay STA. Also, a new target wake time (TWT) schedule may be configured to coordinate power-saving operations, such as wake and sleep periods within the new relay topology.

The drawing illustrates how a relay path can be dynamically and adaptively configured in a wireless network to sustain quality of service (QoS) and maintain network coverage in response to evolving wireless network conditions.

However, as noted earlier, the existing relay setup procedure does not provide a mechanism to exchange DPS capability information. For example, during step 4, where the relay link is established, the relay STA does not communicate any information regarding its DPS capabilities or preferences to the target/relayed STA it will serve (and vice versa). The lack of information may restrict the wireless network’s ability to optimize power-saving behavior. For example, it may result in inefficient relay scheduling, increased power consumption, and/or unnecessary wake periods for both the relay STA and the relayed STA.

Also, the existing IEEE 802.11 wireless networking standards do not provide a unified framework for signaling support for power-saving features. Each new version of the wireless networking standard introduces its own power-saving enhancements and embeds the associated capability information into separate and often fragmented subfields across multiple elements. This fragmented signaling approach limits extensibility and increases implementation complexity, especially as more sophisticated power management mechanisms are introduced.

To address the limitations of existing relay configurations, which lack explicit coordination/signaling for power-saving operations, this present disclosure introduces a new DPS feature capabilities IE that is specifically designed for relay-enabled wireless networks. This IE may explicitly specify DPS-related capabilities and operational preferences including, but not limited to, support for low capability mode and support for DPS mode transitions via initial control frame and initial control response frame exchanges. Relay STAs may use the DPS feature capabilities IE to communicate its DPS-related capabilities during protocol interactions such as during association, re-association, and relay setup procedures (e.g., steps 1, 2, and 3 shown in FIG. 14).

While a DPS feature capabilities IE is described herein that can be used with DPS, it should be appreciated that the DPS feature capabilities IE can be used with other types of dynamic (or short-term) power saving schemes.

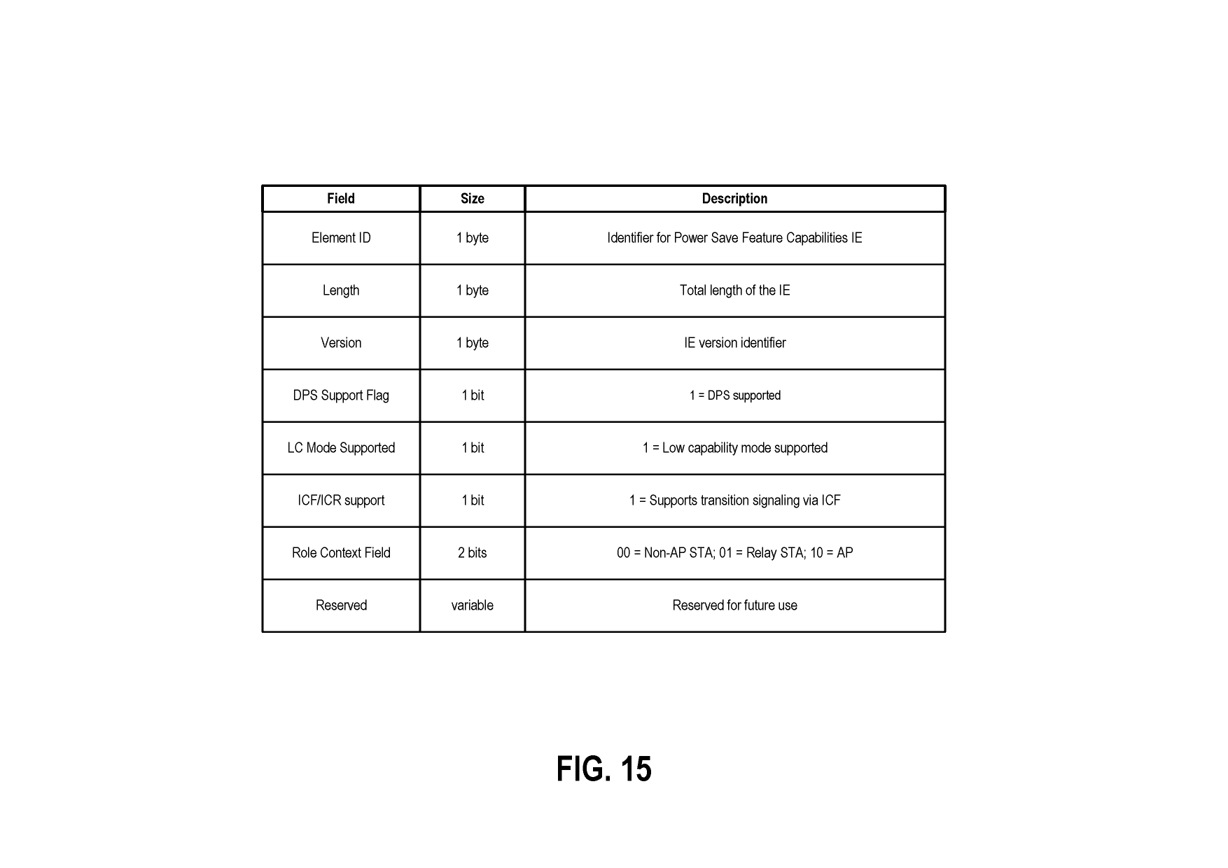

FIG. 15 is a table showing a structure of a dynamic power save (DPS) feature capabilities information element (IE), according to some embodiments.

As shown in the table, a DPS feature capabilities IE may include an element ID field (1 byte), a length field (1 byte), a version field (1 byte), a DPS support flag field (1 bit), a LC mode supported field (1 bit), an ICF/ICR support field (1 bit), a role context field (2 bits), and a reserved field (variable length).

The element ID field may carry an identifier for the dynamic power save feature capabilities IE. The length field may carry an indication of the total length of the IE. The version field may carry an IE version identifier. The DPS support flag field may carry a flag indicating whether DPS is supported or not. For example, if the flag is set to binary “1” it may indicate that DPS is supported, and otherwise indicate that DPS is not supported. The LC mode supported field may carry a flag indicating whether LC (low capability) mode is supported. For example, if the flag is set to binary “1” it may indicate that low capability mode is supported, and otherwise indicate that low capability mode is not supported. The ICF/ICR support field may carry a flag indicating whether ICF/ICR signaling is supported (for DPS mode transitions). For example, if the flag is set to binary “1” it may indicate that ICF/ICR signaling is supported, and otherwise indicate that ICF/ICR signaling is not supported. The role context field may carry an indication of the role of the transmitter. For example, if the role context field carries a value of binary “00” it may indicate the STA role, if the role context field carries a value of binary “01” it may indicate the relay STA role, and if the role context field carries a value of binary “10” it may indicate the AP role. The reserved field may be reserved for future use.

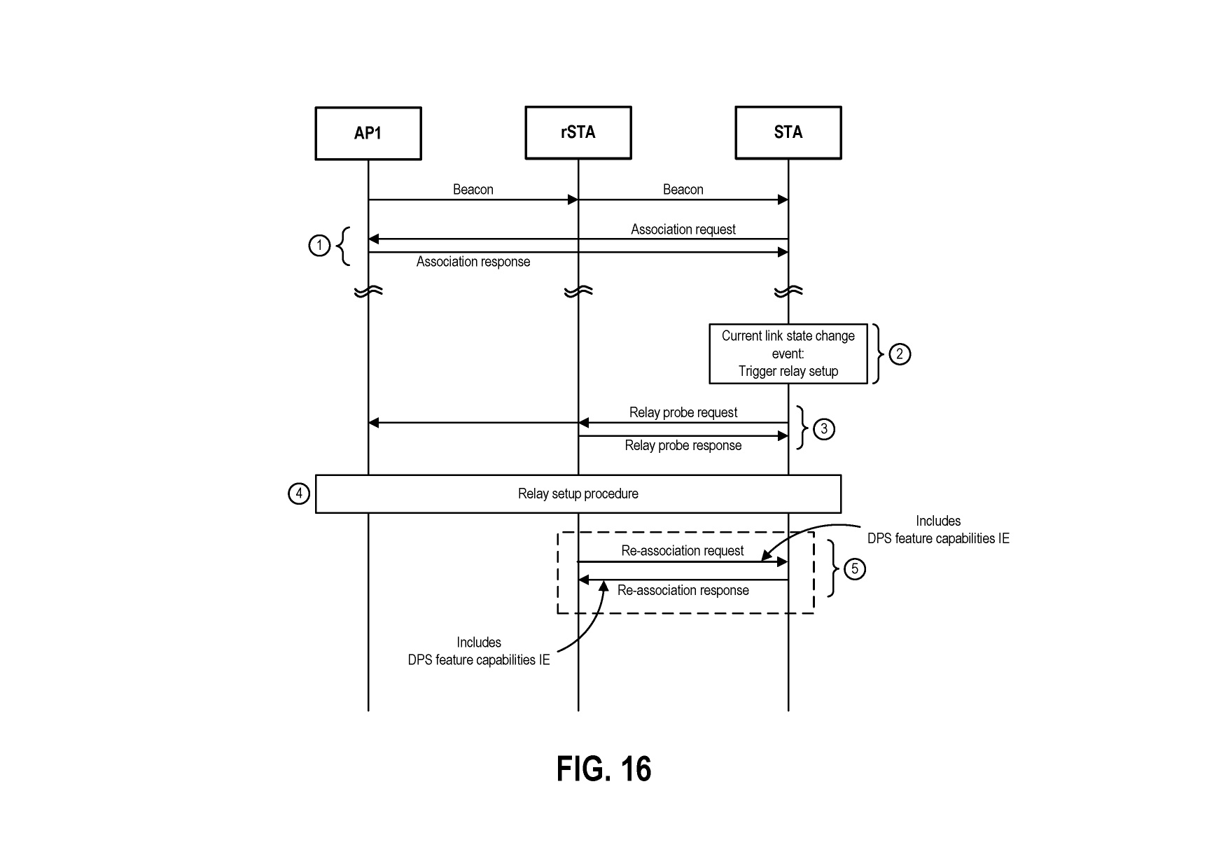

Embodiments integrate this DPS feature capabilities IE into existing management frames such as association request/response frames, re-association request/response frames, and/or relay setup request message frames to ensure seamless compatibility/integration with the existing wireless networking standards. With this DPS feature capability IE, APs and relayed STAs can become aware of the relay STA’s power-saving capabilities/behavior to enable dynamic DPS-aware scheduling. Such approach can improve both energy efficiency and communication reliability in a scalable way. An example of how the DPS feature capabilities IE can be incorporated into the relay setup procedure is shown in FIG. 16.

FIG. 16 is a diagram showing a relay configuration/setup procedure that includes explicit DPS capability exchange via a re-association request and response exchange, according to some embodiments.

As shown in the diagram, the AP, relay STA, and destination STA may perform steps 1-4 shown in FIG. 14 and described above. After completing the relay setup procedure (at step 4), the relay STA may transmit a re-association request frame to the destination STA that includes a DPS feature capabilities IE. This DPS feature capabilities IE may include information regarding the DPS capability of the relay STA. Responsive to receiving the re-association request frame, the destination STA may transmit a re-association response frame to the relay STA that includes a DPS feature capabilities IE. This DPS feature capabilities IE may include information regarding the DPS capability of the destination STA. As a result, the relay STA may become aware of the DPS capability of the destination STA. Likewise, the destination STA may become aware of the DPS capability of the relay STA.

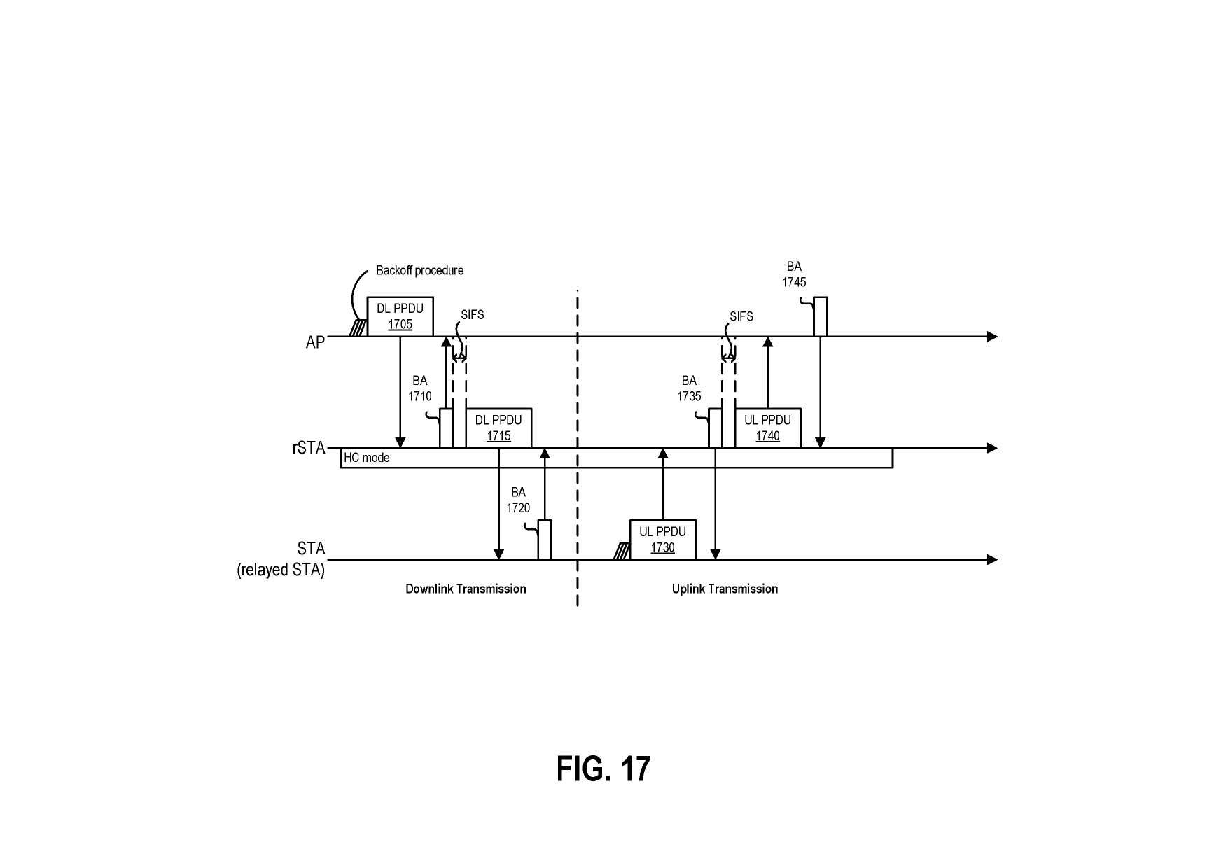

FIG. 17 is a diagram showing a relay operation sequence, according to some embodiments.

The diagram shows a relay operation sequence in which the relay STA only operates in the high capability (HC) mode where DPS is not enabled. Throughout the sequence, the relay STA remains operating in the high capability mode. This represents a conventional relay approach where the low capability (LC) mode is not leveraged even during periods of inactivity or lower traffic load.

In the downlink scenario, after performing a backoff procedure, the AP may transmit downlink physical layer protocol data unit (DL PPDU) 1705 carrying data intended for the relayed STA to the relay STA. Responsive to receiving DL PPDU 1705, the relay STA may transmit block acknowledgement (BA) frame 1710 to the AP. After a SIFS interval after transmitting BA frame 1710, the relay STA may transmit DL PPDU 1715 that carries the data intended for the relayed STA (that was received in DL PPDU 1705) to the relayed STA while bypassing any contention-based channel access mechanisms. Responsive to receiving DL PPDU 1715, the relayed STA may transmit BA frame 1720 to the relay STA.

In the uplink scenario, after performing a backoff procedure, the relayed STA may transmit an uplink (UL) PPDU 1730 carrying data intended for the AP to the relay STA. Responsive to receiving UL PPDU 1730, the relay STA may transmit BA frame 1735 to the relayed STA. After a SIFS interval after transmitting BA frame 1735, the relay STA may transmit UL PPDU 1740 that carries the data intended for the AP (that was received in UL PPDU 1730) to the AP while bypassing any contention-based channel access mechanisms. Responsive to receiving UL PPDU 1740, the AP may transmit BA frame 1745 to the relay STA.

The relay operation sequence shown in the diagram assumes that the relay STA can immediately forward data after a SIFS interval while bypassing contention-based channel access mechanisms. Other implementations may use a different relay approach.

Notably, the relay operation sequence shown in the diagram does not leverage DPS signaling, as evidenced by the lack of an initial control frame and initial control response frame exchange. The relay STA always operates in the high capability mode regardless of the level of traffic. This may result in unnecessary power usage, reinforcing the need for a DPS-aware relay framework that incorporates explicit DPS signaling to enable DPS mode transitions based on real-time transmission needs.

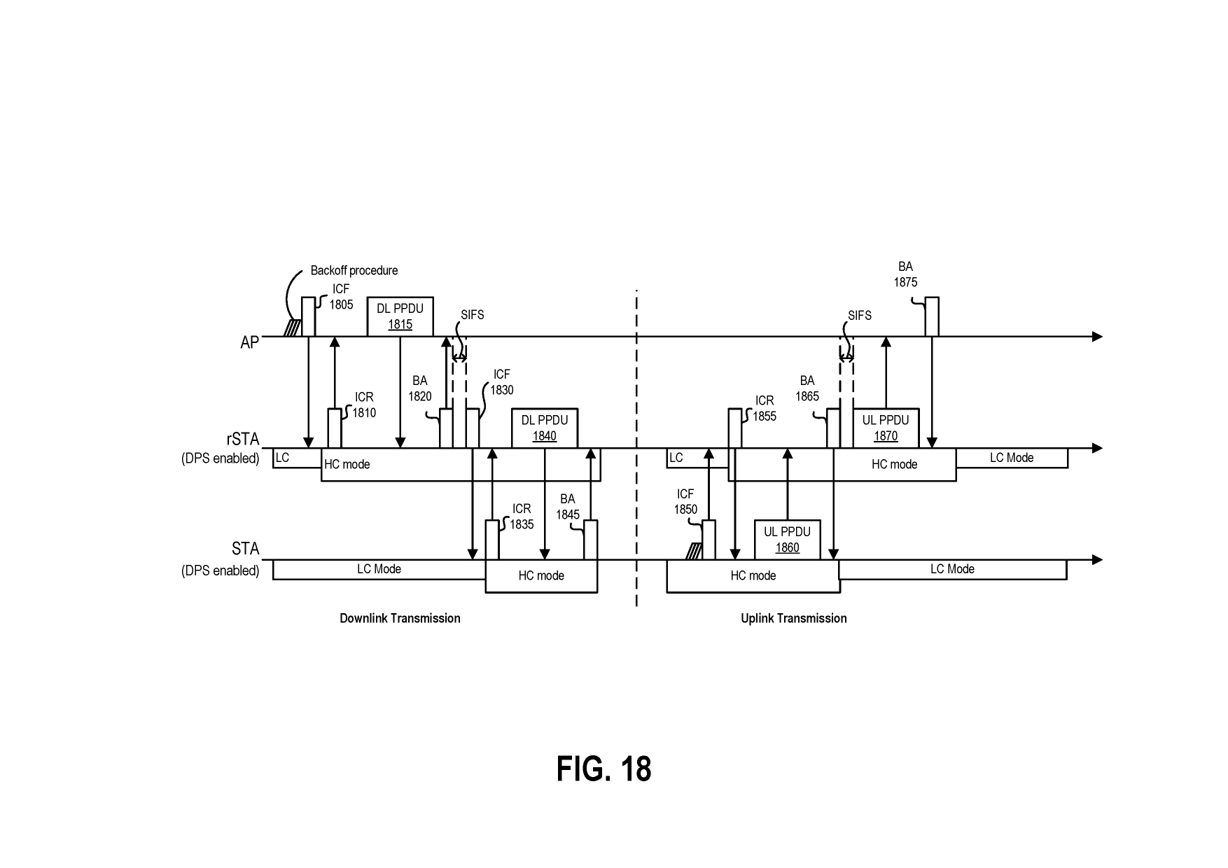

FIG. 18 is a diagram showing a DPS-enabled relay operation sequence with a two-stage ICF/ICR exchange, according to some embodiments.

The diagram shows a DPS-enabled relay operation in a wireless network that highlights how the relay STA transitions from operating in a low capability mode to operating in a high capability mode based on ICF/ICR signaling to support both downlink (DL) and uplink (UL) transmissions. The example shown in the diagram builds on the previous example shown in FIG. 17 to introduce dynamic mode transitions that can help conserve energy.

In the downlink scenario, the relay STA begins by operating in the low capability mode to minimize power consumption. When the AP prepares for performing a downlink transmission to the relayed STA, the AP may transmit initial control frame 1805 to the relay STA (after performing a backoff period). This initial control frame 1805 serves as a trigger to cause the relay STA to transition from operating in the low capability mode to operating in the high capability mode. Responsive to receiving initial control frame 1805, the relay STA may transition from operating in the low capability mode to operating in the high capability mode and transmit initial control response frame 1810 to the AP to confirm the transition. After the relay STA has transitioned to operating in the high capability mode, the AP may transmit DL PPDU 1815 that carries data intended for the relayed STA to the relay STA. Responsive to receiving DL PPDU 1815, the relay STA may transmit BA frame 1820 to the AP. After a SIFS interval after transmitting BA frame 1820, the relay STA may transmit initial control frame 1830 to the relayed STA (which in this example is a DPS-enabled STA) to cause the relayed STA to transition from operating in the low capability mode to operating in the high capability mode (while bypassing any contention-based access mechanisms). Responsive to receiving initial control frame 1830, the relayed STA may transition from operating in the low capability mode to operating in the high capability mode and transmit initial control response frame 1835 to the AP to confirm the transition. After the relayed STA has transitioned to operating in the high capability mode, the relay STA may transmit DL PPDU 1840 that carries the data intended for the relayed STA (the data that was received in DL PPDU 1815) to the relayed STA. Responsive to receiving DL PPDU 1840, the relayed STA may transmit BA frame 1845 to the relay STA. A similar process can be repeated for any additional DL PPDUs that need to be transmitted.

In the uplink scenario, the relayed STA may transmit initial control frame 1850 to the relay STA to cause the relay STA to transition from operating in the low capability mode to operating in the high capability mode. Responsive to receiving initial control frame 1850, the relay STA may transition from operating in the low capability mode to operating in the high capability mode and transmit initial control response frame 1855 to the relayed STA. After the relay STA has transitioned to operating in the high capability mode, the relayed STA may transmit UL PPDU 1860 that carries data intended for the AP to the relay STA. Responsive to receiving UL PPDU 1860, the relay STA may transmit BA frame 1865 to the relayed STA. The relayed STA may then transition back to operating in the low capability mode to conserve energy. After a SIFS interval after transmitting BA frame 1865, the relay STA may transmit UL PPDU 1870 that carries the data intended for the relayed STA (the data that was received in UL PPDU 1860) to the AP (while bypassing any contention-based access mechanisms). Responsive to receiving UL PPDU 1870, the AP may transmit BA frame 1875 to the relay STA. A similar process can be repeated for any additional UL PPDUs that need to be transmitted. After the uplink transmission session has completed, the relay STA may transition back to operating in the low capability mode to conserve energy.

While the approach shown in the diagram allows for fine-grained control of power consumption modes and reliable data relaying, the downlink scenario incurs higher signaling overhead compared to the uplink scenario due to having two separate ICF/ICR exchanges (two-stage ICF/ICR exchange) – a first exchange between the AP and the relay STA and a second exchange between the relay STA and the relayed STA. The uplink scenario only requires a single ICF/ICR exchange, making it more lightweight in terms of signaling overhead. This observation highlights the potential for optimizing downlink relay operations by reducing redundant signaling overhead in relay operations leveraging DPS.

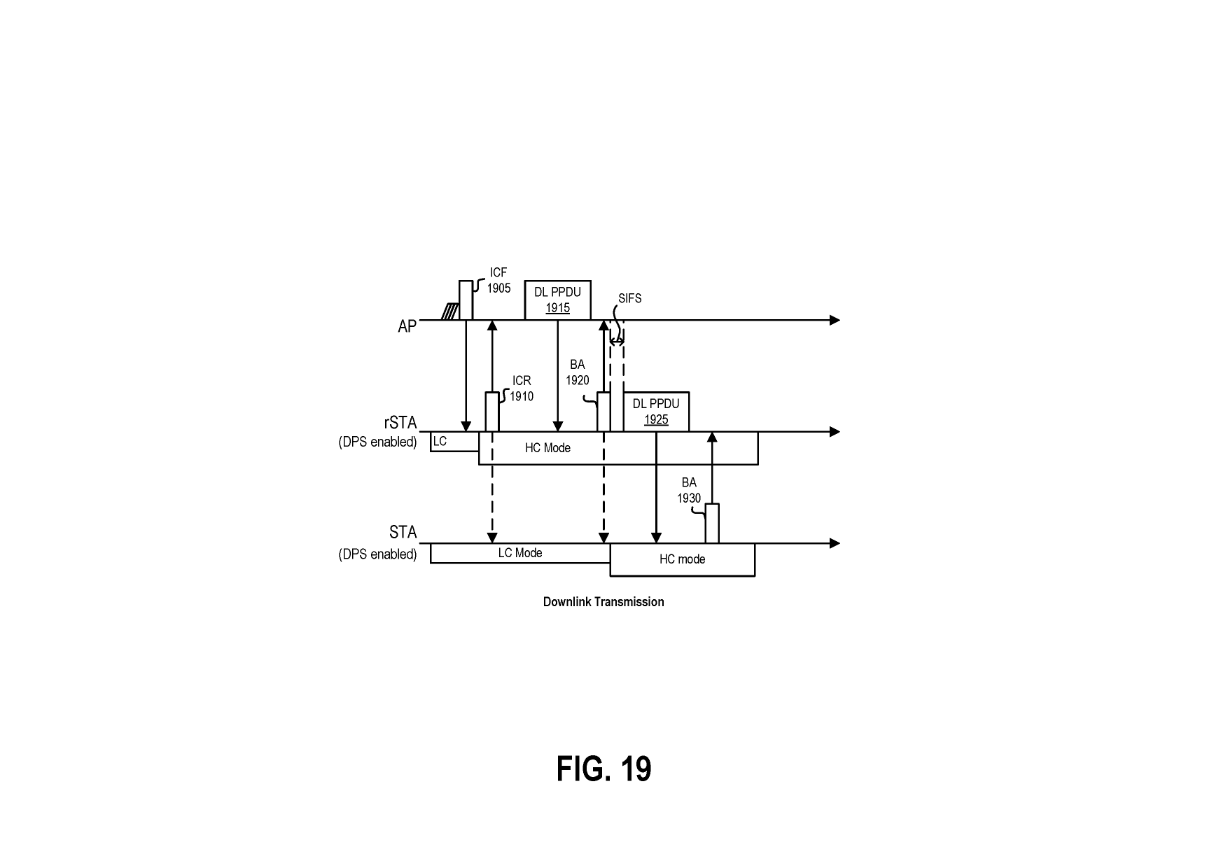

FIG. 19 is a diagram showing a downlink relay operation sequence that uses a dual-purpose initial control response frame signaling technique, according to some embodiments.

The diagram shows an optimized downlink relay operation sequence for a DPS-enabled wireless network, where the initial control response frame transmitted by the relay STA serves a dual purpose. In particular, from the perspective of the AP, the initial control response frame serves to acknowledge the initial control frame transmitted by the AP. Also, from the perspective of the relayed STA, the initial control response frame serves to signal that the relayed STA should transition from operating in the low capability mode to operating in the high capability mode. The optimized downlink relay operation sequence shown in the diagram may reduce signaling overhead compared to the conventional two-stage ICF/ICR exchange approach (e.g., the approach shown in FIG. 18), thereby improving overall communication efficiency.

As shown in the diagram, the relay STA initially operates in the low capability mode to minimize power consumption. When the AP has downlink data to transmit to the relayed STA, it may transmit initial control frame 1905 to the relay STA to cause the relay STA to transition from operating in the low capability mode to operating in the high capability mode. Responsive to receiving initial control frame 1905, the relay STA may transition from operating in the low capability mode to operating in the high capability mode and transmit initial control response frame 1910 to the AP. After the relay STA has transitioned to operating in the high capability mode, the AP may transmit DL PPDU 1915 that carries data intended for the relayed STA to the relay STA. Responsive to receiving DL PPDU 1915, the relay STA may transmit BA frame 1920 to the AP.

The relayed STA, which is also DPS-enabled and initially operating in the low capability mode, may overhear initial control response frame 1910 transmitted by the relay STA. Based on analyzing the information carried within this initial control response frame 1910, the relayed STA may infer: (1) that the relay STA will be relaying downlink data to itself; and (ii) the appropriate timing to transition to operating in the high capability mode. In an embodiment, the relayed STA does not immediately transition to operating in the high capability mode upon overhearing initial control response frame 1910, but instead uses timing information carried in the overheard initial control response frame 1910 such as network allocation vector (NAV) information (e.g., any type of information that is used for setting NAV such as duration information) to determine when to schedule its DPS mode transition. This approach allows the relayed STA to delay its DPS mode transition until closer to the time that it needs to receive the relayed downlink data, which can help maximize energy efficiency. In another embodiment, the relayed STA uses the subsequent BA frame 1920 that is transmitted by the relay STA as a signal to transition to operating in the high capability mode. That is, the relayed STA may transition from operating in the low capability mode to operating in the high capability mode in response to overhearing BA frame 1920 transmitted by the relayed STA. In this example, the relayed STA transitions from operating in the low capability mode to operating in the high capability mode around the time that the relay STA transmits BA frame 1920.

After a SIFS interval after transmitting BA frame 1920, the relay STA may transmit DL PPDU 1925 that carries the data intended for the relayed STA (the data that was received in DL PPDU 1915) to the relayed STA (which is operating in the high capability mode by this time). Responsive to receiving DL PPDU 1925, the relayed STA may transmit BA frame 1930 to the relay STA.

By using the NAV timing information from the initial control frame or the reception of the relayed STA’s BA frame transmission as its DPS mode transition trigger, the relayed STA may reduce unnecessary power consumption and optimize energy management when performing relay operations. This enhanced signaling method streamlines relay operations by reducing overhead, latency, and contention, while maintaining robust and energy-efficient DPS functionality.

The dynamic power saving-aware relay framework described here may provide several benefits including one or more of the benefits mentioned below.

Enhanced power efficiency: by explicitly signaling dynamic power saving capabilities, the relay STA and relayed STAs may know when dynamic power saving can be leveraged to reduce power consumption during idle periods or low-activity periods.

Reduced signaling overhead: the dual-purpose initial control response frame signaling technique may reduce the number of frames that are needed to effectuate dynamic power saving mode transitions, which can reduce the overall signaling overheard and latency and increase channel utilization.

Seamless compatibility: the DPS feature capabilities IE may seamlessly integrate into existing management frames defined in the IEEE 802.11 wireless networking standards (e.g., association request/response frame, re-association request/response frame, and/or relay setup request frames), which enables seamless integration and adoption into existing wireless networks.

Improved reliability and scalability: the clear and explicit communication/signaling of DPS capabilities may enhance the reliability of data forwarding/relay across extended coverage areas and provide a scalable solution that can help meet the evolving requirements of next-generation wireless networks.

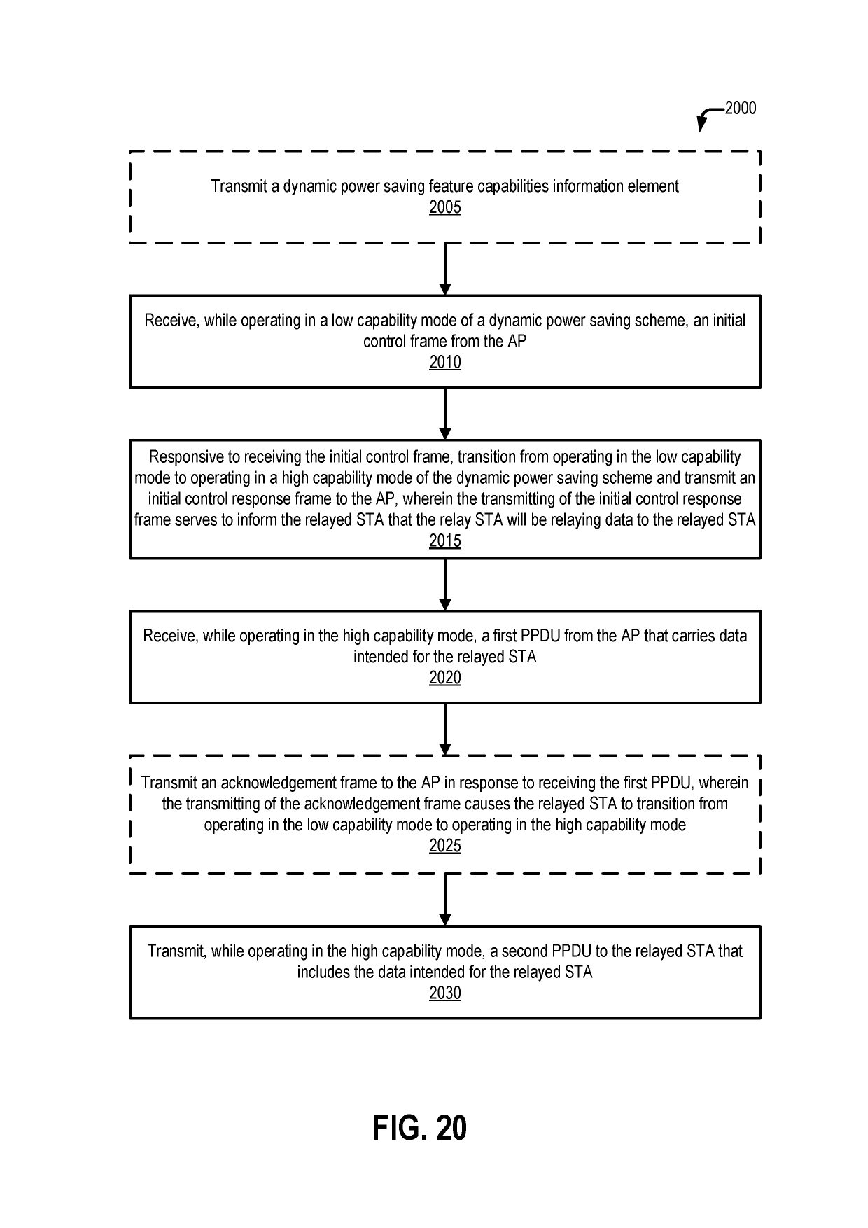

Turning now to FIG. 20, a method 2000 will be described for acting as a relay between an AP and a relayed STA, in accordance with an example embodiment. The method 2000 may be performed by a relay STA. The relay STA may be implemented by a wireless device (e.g., wireless device 104).

In an embodiment, at operation 2005, the relay STA transmits a dynamic power saving feature capabilities information element (e.g., a DPS feature capabilities information element). In an embodiment, the dynamic power saving feature capabilities information element carries an indication that the relay STA supports the dynamic power saving scheme. In an embodiment, the dynamic power saving feature capabilities information element carries an indication that the relay STA supports the low capability (LC) mode. In an embodiment, the dynamic power saving feature capabilities information element carries an indication that the relay STA supports initial control frame (ICF) and initial control response frame (ICR) exchange for power save mode transitions. In an embodiment, the dynamic power saving feature capabilities information element is included in an association response frame, a re-association response frame, or a relay setup request frame transmitted by the relay STA.

At operation 2010, the relay STA receives, while operating in a low capability mode of a dynamic power saving scheme, an initial control frame from the AP.

At operation 2015, responsive to receiving the initial control frame, the relay STA transitions from operating in the low capability mode to operating in a high capability mode of the dynamic power saving scheme and transmits an initial control response frame to the AP, wherein the transmitting of the initial control response frame serves to inform the relayed STA that the relay STA will be relaying data to the relayed STA. In an embodiment, the initial control response frame carries timing information that the relayed STA uses to determine a time at which to transition from operating in the low capability mode to operating in the high capability mode. In an embodiment, the timing information includes NAV information. In an embodiment, the dynamic power saving scheme is DPS.

At operation 2020, the relay STA receives, while operating in the high capability mode, a first PPDU from the AP that carries data intended for the relayed STA.

In an embodiment, at operation 2025, the relay STA transmits an acknowledgement frame to the AP in response to receiving the first PPDU, wherein the transmitting of the acknowledgement frame causes the relayed STA to transition from operating in the low capability mode to operating in the high capability mode.

At operation 2030, the relay STA transmits, while operating in the high capability mode, a second PPDU to the relayed STA that includes the data intended for the relayed STA. Notably, the second PPDU can be transmitted without having to transmit a separate initial control frame or other type of signal to the relayed STA to cause the relayed STA to transition from operating in the low capability mode to operating in the high capability mode because the relayed STA may know to transition modes based on overhearing the initial control response frame transmitted by the relay STA.

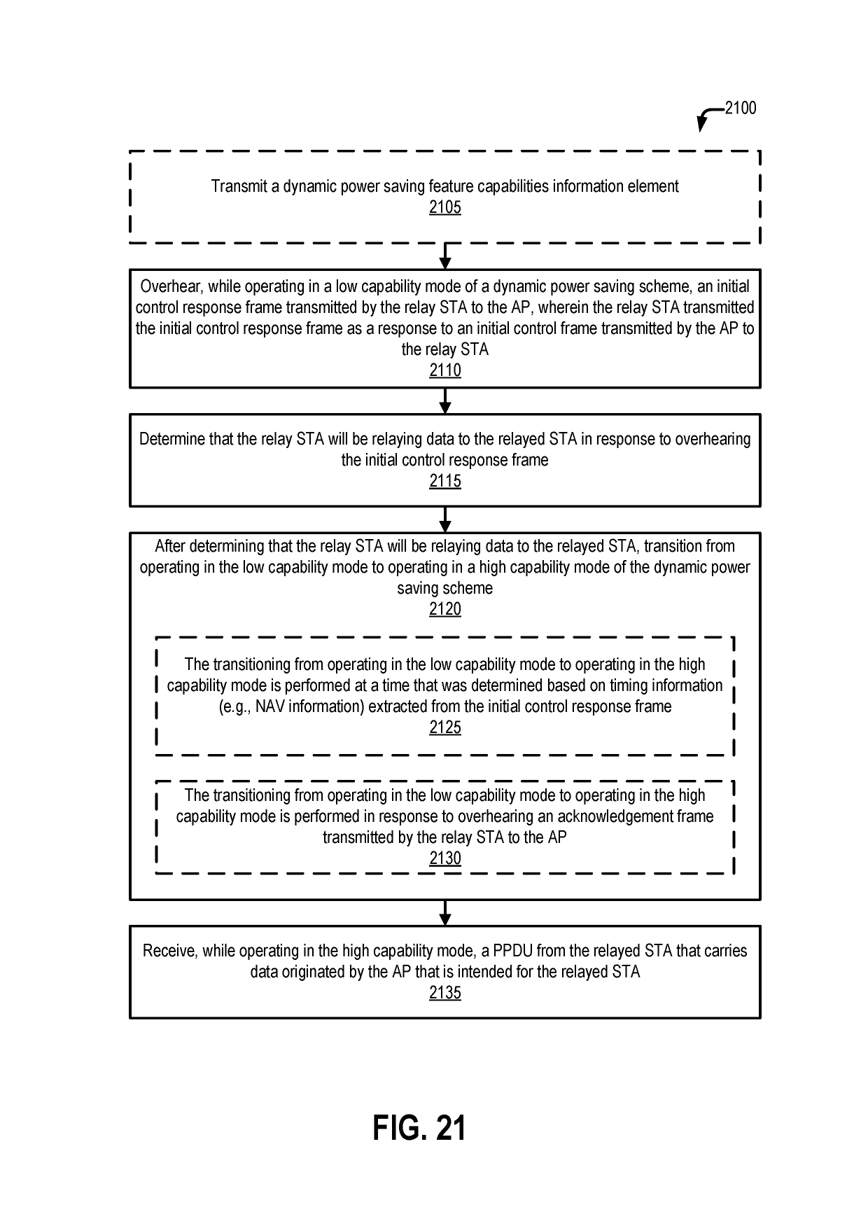

Turning now to FIG. 21, a method 2100 will be described for receiving data from an AP via a relay STA, in accordance with an example embodiment. The method 2100 may be performed by a relayed STA. The relayed STA may be implemented by a wireless device (e.g., wireless device 104).

In an embodiment, at operation 2105, the relayed STA transmits a dynamic power saving feature capabilities information element (e.g., a DPS feature capabilities information element). In an embodiment, the dynamic power saving feature capabilities information element carries an indication that the relayed STA supports the dynamic power saving scheme. In an embodiment, the dynamic power saving feature capabilities information element carries an indication that the relayed STA supports the low capability (LC) mode. In an embodiment, the dynamic power saving feature capabilities information element carries an indication that the relayed STA supports initial control frame (ICF) and initial control response frame (ICR) exchange for power save mode transitions. In an embodiment, the dynamic power saving feature capabilities information element is included in an association request frame, a re-association request frame, or a relay setup request frame transmitted by the relayed STA.

At operation 2110, the relayed STA overhears, while operating in a low capability mode of a dynamic power saving scheme, an initial control response frame transmitted by the relay STA to the AP, wherein the relay STA transmitted the initial control response frame as a response to an initial control frame transmitted by the AP to the relay STA. In an embodiment, the dynamic power saving scheme is DPS.

At operation 2115, the relayed STA determine that the relay STA will be relaying data to the relayed STA in response to overhearing the initial control response frame.

At operation 2120, after determining that the relay STA will be relaying data to the relayed STA, the relayed STA transitions from operating in the low capability mode to operating in a high capability mode of the dynamic power saving scheme. In an embodiment, as shown by block 2125, the transitioning from operating in the low capability mode to operating in the high capability mode is performed at a time that was determined based on timing information (e.g., NAV information) extracted from the initial control response frame. In an embodiment, as shown by block 2130, the transitioning from operating in the low capability mode to operating in the high capability mode is performed in response to overhearing an acknowledgement frame (e.g., BA frame 1920 shown in FIG. 19) transmitted by the relay STA to the AP.

At operation 2135, the relayed STA receives, while operating in the high capability mode, a PPDU from the relayed STA that carries data originated by the AP that is intended for the relayed STA.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a relay station (STA) to act as a relay between an access point (AP) and a relayed STA, the method comprising:
receiving, while operating in a low capability mode of a dynamic power saving scheme, an initial control frame from the AP;
responsive to receiving the initial control frame, transitioning from operating in the low capability mode to operating in a high capability mode of the dynamic power saving scheme and transmitting an initial control response frame to the AP, wherein the transmitting of the initial control response frame serves to inform the relayed STA that the relay STA will be relaying data to the relayed STA;
receiving, while operating in the high capability mode, a first physical layer protocol data unit (PPDU) from the AP that carries data intended for the relayed STA; and
transmitting, while operating in the high capability mode, a second PPDU to the relayed STA that includes the data intended for the relayed STA.

2. The method of claim 1, wherein the initial control response frame carries timing information that the relayed STA uses to determine a time at which to transition from operating in the low capability mode to operating in the high capability mode.

3. The method of claim 2, wherein the timing information includes network allocation vector (NAV) information.

4. The method of claim 1, further comprising:
transmitting an acknowledgement frame to the AP in response to receiving the first PPDU, wherein the transmitting of the acknowledgement frame causes the relayed STA to transition from operating in the low capability mode to operating in the high capability mode.

5. The method of claim 1, further comprising:
transmitting a dynamic power saving feature capabilities information element.

6. The method of claim 5, wherein the dynamic power saving feature capabilities information element carries an indication that the relay STA supports the dynamic power saving scheme.

7. The method of claim 5, wherein the dynamic power saving feature capabilities information element carries an indication that the relay STA supports the low capability mode.

8. The method of claim 5, wherein the dynamic power saving feature capabilities information element carries an indication that the relay STA supports initial control frame and initial control response frame exchange for power save mode transitions.

9. The method of claim 5, wherein the dynamic power saving feature capabilities information element is included in an association response frame, a re-association response frame, or a relay setup request frame transmitted by the relay STA.

10. A method performed by a relayed station (STA) to receive data from an access point (AP) via a relay STA, the method comprising:
overhearing, while operating in a low capability mode of a dynamic power saving scheme, an initial control response frame transmitted by the relay STA to the AP, wherein the relay STA transmitted the initial control response frame as a response to an initial control frame transmitted by the AP to the relay STA;
determining that the relay STA will be relaying data to the relayed STA in response to overhearing the initial control response frame;
after determining that the relay STA will be relaying data to the relayed STA, transitioning from operating in the low capability mode to operating in a high capability mode of the dynamic power saving scheme; and
receiving, while operating in the high capability mode, a physical layer protocol data unit (PPDU) from the relayed STA that carries data originated by the AP that is intended for the relayed STA.

11. The method of claim 10, further comprising:
extracting timing information from the initial control response frame; and
determining a time at which to transition from operating in the low capability mode to operating in the high capability mode based on the extracted timing information, wherein the transitioning from operating in the low capability mode to operating in the high capability mode is performed at the determined time.

12. The method of claim 11, wherein the timing information includes network allocation vector (NAV) information.

13. The method of claim 10, further comprising:
after determining that the relay STA will be relaying data to the relayed STA, overhearing an acknowledgement frame transmitted by the relay STA to the AP, wherein the transitioning from operating in the low capability mode to operating in the high capability mode is performed in response to overhearing the acknowledgement frame.

14. The method of claim 10, further comprising:
transmitting a dynamic power saving feature capabilities information element.

15. The method of claim 14, wherein the dynamic power saving feature capabilities information element carries an indication that the relayed STA supports the dynamic power saving scheme.

16. The method of claim 14, wherein the dynamic power saving feature capabilities information element carries an indication that the relayed STA supports the low capability mode.

17. The method of claim 14, wherein the dynamic power saving feature capabilities information element carries an indication that the relayed STA supports initial control frame and initial control response frame exchange for power save mode transitions.

18. The method of claim 14, wherein the dynamic power saving feature capabilities information element is included in an association request frame, a re-association request frame, or a relay setup request frame transmitted by the relayed STA.

19. A wireless device to implement a relay station (STA), the wireless device comprising:
a radio frequency transceiver;
a memory device storing a set of instructions; and
a processor coupled to the memory device, wherein the set of instructions, when executed by the processor, causes the relay STA to:
receive, while operating in a low capability mode of a dynamic power saving scheme, an initial control frame from an access point (AP);
responsive to receiving the initial control frame, transition from operating in the low capability mode to operating in a high capability mode of the dynamic power saving scheme and transmit an initial control response frame to the AP, wherein the transmitting of the initial control response frame serves to inform the relayed STA that the relay STA will be relaying data to the relayed STA;
receive, while operating in the high capability mode, a first physical layer protocol data unit (PPDU) from the AP that carries data intended for the relayed STA; and
transmit, while operating in the high capability mode, a second PPDU to the relayed STA that includes the data intended for the relayed STA.

20. A wireless device to implement a relayed station (STA), the wireless device comprising:
a radio frequency transceiver;
a memory device storing a set of instructions; and
a processor coupled to the memory device, wherein the set of instructions, when executed by the processor, causes the relayed STA to:
overhear, while operating in a low capability mode of a dynamic power saving scheme, an initial control response frame transmitted by a relay STA to an access point (AP), wherein the relay STA transmitted the initial control response frame as a response to an initial control frame transmitted by the AP to the relay STA;
determine that the relay STA will be relaying data to the relayed STA in response to overhearing the initial control response frame;
after determining that the relay STA will be relaying data to the relayed STA, transition from operating in the low capability mode to operating in a high capability mode of the dynamic power saving scheme; and
receive, while operating in the high capability mode, a physical layer protocol data unit (PPDU) from the relayed STA that carries data originated by the AP that is intended for the relayed STA.
